(19) United States
(12) Patent Application Publication
(10) Pub. No.: US 2026/0112279 A1
(43) Pub. Date: Apr. 23, 2026

(54) SYSTEMS AND METHODS FOR A UNIVERSAL INTERACTIVE EXTENDED REALITY DETECTOR SWEEP TRAINER

(71) Applicant: Vectrona, LLC, Virginia Beach, VA (US)

(72) Inventors: Joseph Edward GELARDI, Virginia Beach, VA (US); Eric JOHNSON, Virginia Beach, VA (US); Taylor WHITE, Virginia Beach, VA (US)

(21) Appl. No.: 19/362,820

(22) Filed: Oct. 20, 2025

Related U.S. Application Data
(60) Provisional application No. 63/709,267, filed on Oct. 18, 2024.

(51) Int. Cl. G09B 5/02; G09B 5/04

(52) U.S. Cl. CPC G09B 5/02; G09B 5/04

(57) ABSTRACT

A method, computer program product, and computer system for receiving, by a computing device of a handheld detector, usage data of the handheld detector operated by a user. Performance parameters for how the user is operating the handheld detector may be determined based on the usage data received from the handheld detector. Feedback outputs for how the user is operating the handheld detector may be generated based on the performance parameters. The feedback outputs may be presented to the user.

### RELATED CASES

This application claims the benefit of U.S. Provisional Application No. 63/709,267, filed on 18 October 2024, which is incorporated by reference herein in its entirety.

### BACKGROUND

Generally, manual detector technologies may be used across military, commercial, and humanitarian operations for locating, e.g., underground infrastructure and concealed objects. However, effective training in their use requires much more than detecting targets based on their material properties. Training should be focused not only on the detector’s path across the ground, but also should critically address sweep technique elements, such as detector head height, sweep speed, and sensor angle to ensure proper detection coverage and capability. Current training is understood to be based solely on the subjective feedback provided by the imprecise observations of a human instructor whose feedback is limited based on contact time with the trainee, personal experience, and individual technique. This form of training lacks the ability to provide operators with direct real-time feedback on the essential parameters they need for proficiency in detecting buried threats, such as explosives.

### SUMMARY

In one example implementation, a method, performed by one or more computing devices, may include but is not limited to receiving, by a computing device of a handheld detector, usage data of the handheld detector operated by a user. Performance parameters for how the user is operating the handheld detector may be determined based on the usage data received from the handheld detector. Feedback outputs for how the user is operating the handheld detector may be generated based on the performance parameters. The feedback outputs may be presented to the user.

One or more of the following example features may be included. Presenting the feedback outputs to the user may include presenting the feedback outputs through at least one of a head-mounted display, an external display, an on-detector visual indicator, an on-detector haptic actuator, a wearable haptic device, a spatialized audio device, a projection guidance, a laser guidance, and a mobile display. Presenting the feedback outputs to the user may include transitioning between a scanning state and an interrogation state, wherein the feedback outputs presented to the user include state-specific cues for at least one of centroid refinement, depth estimation, footprint estimation, standardized mark workflows and standardized report workflows. Receiving the usage data of the handheld detector may include receiving at least one of head height of the handheld detector, sweep cadence of the handheld detector, lateral coverage of the handheld detector, and angle of the handheld detector. Receiving the usage data of the handheld detector may include receiving the usage data from external tracking sensors and internal motion tracking sensors of the handheld detector. Receiving the usage data of the handheld detector may include receiving the usage data of the handheld detector through a simulation of operational conditions. Individual performance of the user may be tracked, group performance from a plurality of users may be tracked, training data may be stored, and performance reports for the user and the plurality of users may be generated.

In another example implementation, a computing system may include one or more processors and one or more memories configured to perform operations that may include but are not limited to receiving, by a computing device of a handheld detector, usage data of the handheld detector operated by a user. Performance parameters for how the user is operating the handheld detector may be determined based on the usage data received from the handheld detector. Feedback outputs for how the user is operating the handheld detector may be generated based on the performance parameters. The feedback outputs may be presented to the user.

One or more of the following example features may be included. Presenting the feedback outputs to the user may include presenting the feedback outputs through at least one of a head-mounted display, an external display, an on-detector visual indicator, an on-detector haptic actuator, a wearable haptic device, a spatialized audio device, a projection guidance, a laser guidance, and a mobile display. Presenting the feedback outputs to the user may include transitioning between a scanning state and an interrogation state, wherein the feedback outputs presented to the user include state-specific cues for at least one of centroid refinement, depth estimation, footprint estimation, standardized mark workflows and standardized report workflows. Receiving the usage data of the handheld detector may include receiving at least one of head height of the handheld detector, sweep cadence of the handheld detector, lateral coverage of the handheld detector, and angle of the handheld detector. Receiving the usage data of the handheld detector may include receiving the usage data from external tracking sensors and internal motion tracking sensors of the handheld detector. Receiving the usage data of the handheld detector may include receiving the usage data of the handheld detector through a simulation of operational conditions. Individual performance of the user may be tracked, group performance from a plurality of users may be tracked, training data may be stored, and performance reports for the user and the plurality of users may be generated.

In another example implementation, a computer program product may reside on a computer readable storage medium having a plurality of instructions stored thereon which, when executed across one or more processors, may cause at least a portion of the one or more processors to perform operations that may include but are not limited to receiving, by a computing device of a handheld detector, usage data of the handheld detector operated by a user. Performance parameters for how the user is operating the handheld detector may be determined based on the usage data received from the handheld detector. Feedback outputs for how the user is operating the handheld detector may be generated based on the performance parameters. The feedback outputs may be presented to the user.

One or more of the following example features may be included. Presenting the feedback outputs to the user may include presenting the feedback outputs through at least one of a head-mounted display, an external display, an on-detector visual indicator, an on-detector haptic actuator, a wearable haptic device, a spatialized audio device, a projection guidance, a laser guidance, and a mobile display. Presenting the feedback outputs to the user may include transitioning between a scanning state and an interrogation state, wherein the feedback outputs presented to the user include state-specific cues for at least one of centroid refinement, depth estimation, footprint estimation, standardized mark workflows and standardized report workflows. Receiving the usage data of the handheld detector may include receiving at least one of head height of the handheld detector, sweep cadence of the handheld detector, lateral coverage of the handheld detector, and angle of the handheld detector. Receiving the usage data of the handheld detector may include receiving the usage data from external tracking sensors and internal motion tracking sensors of the handheld detector. Receiving the usage data of the handheld detector may include receiving the usage data of the handheld detector through a simulation of operational conditions. Individual performance of the user may be tracked, group performance from a plurality of users may be tracked, training data may be stored, and performance reports for the user and the plurality of users may be generated.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations. This Summary introduces a selection of concepts in a simplified form that are further described below. This Summary is not intended to identify key features or essential features of the claimed subject matter, nor is it intended to be used to determine the scope of the claimed subject matter.

### BRIEF DESCRIPTION OF DRAWINGS

FIG. 1 is an example diagrammatic view of a trainer process implemented by an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a trainer process according to one or more example implementations of the disclosure;

FIG. 4 is an example diagrammatic view of a handheld sweeper according to one or more example implementations of the disclosure;

FIG. 5 is an example diagrammatic view of a trainer process implemented by an example computing network according to one or more example implementations of the disclosure; and

FIG. 6 is an example diagrammatic view of a screen image report displayed by a trainer process according to one or more example implementations of the disclosure.

Like reference symbols in the various drawings may indicate like elements.

### DESCRIPTION

Generally, manual detector technologies may be used across military, commercial, and humanitarian operations for locating, e.g., underground infrastructure and concealed objects. However, effective training in their use requires much more than detecting targets based on their material properties. Training should be focused not only on the detector’s path across the ground, but also should address sweep technique elements, such as detector head height, sweep speed, and sensor angle to ensure proper detection coverage and capability. Current training is understood to be based solely on the subjective feedback provided by the imprecise observations of a human instructors whose feedback is limited based on contact time with the trainee, personal experience, and individual technique. This form of training lacks the ability to provide operators with direct real-time feedback on the essential parameters they need for proficiency in detecting buried threats, such as explosives.

Proper training in the use of these detectors is important to ensure effective detection and accurate interpretation of sensor feedback. Historically, training has been conducted through live, instructor-led exercises in controlled environments, which lack scalability and flexibility. The inability to deploy effective training solutions in remote, constrained, or large-scale environments has limited the effectiveness and reach of traditional training methods. Trainees learn through repetitive use of physical detectors in designated training areas under the supervision of an experienced instructor. This method, while effective to a degree, has several example and non-exhaustive limitations.

Lack of Immediate and Comprehensive Feedback. Trainees receive verbal feedback based only on an instructor's visual assessment, which may not effectively diagnose key operational errors in detector handling, such as inconsistent sweep height or improper detector angle. Without real-time feedback on sweeping technique, operators often reinforce poor habits.

Inconsistent Training Quality. The quality of training varies significantly depending on the instructor’s experience, the availability of physical training resources, and environmental conditions. Trainees often do not receive standardized feedback, which can lead to varying levels of proficiency.

High Resource Dependency. Traditional training relies heavily on live instructors and physical training lanes, which are expensive to maintain and scale. This reduces the number of training opportunities for operators, limiting their exposure to real-world threats.

Lack of Realism and Flexibility. Most physical training ranges simulate a limited set of environmental factors and do not represent the variety of operational scenarios (e.g., constrained or high-threat environments) that operators may face. This makes it challenging for trainees to adapt to realistic conditions, limiting the scalability and effectiveness of current training methods.

A sweep training device might utilize a ground mat with electromagnetic fields to track an operator’s movement, while the operator held a simulated plastic handle to mimic the feel of a detector and viewed simulated detector readings on a computing device. However, this system was ultimately rejected due to several example and non-limiting shortcomings:

1. Ineffective Tracking and Feedback Mechanism. The system’s tracking mechanism lacked the precision necessary to accurately record and monitor the operator’s movements. The external tracking solution, dependent on the ground mat, was prone to errors and inconsistencies. This led to unreliable feedback on detector handling and sweep patterns, undermining the quality of training. As a result, trainees were unable to identify and correct operational errors in real time.

2. Incomplete Feedback on Key Operating Parameters. The system did not provide real-time feedback on the more beneficial parameters such as sweep speed, detector head height, or detector angle, factors almost essential for successful detection. Without this dynamic feedback, trainees were left to rely solely on subjective observations or post-training corrections. The present disclosure, by contrast, focuses on sweep technique and provides immediate, objective feedback on all these parameters, enabling operators to correct mistakes as they occur and avoid reinforcing poor habits.

3. Cumbersome Setup and Limited Portability. The system required the use of a large ground mat and additional infrastructure to create the training environment. This setup was logistically challenging, especially in field or remote environments where portability is critical. Furthermore, the stationary nature of the system meant it could not be rapidly deployed or adapted to different training environments. By contrast, the present disclosure training system offers portability and flexibility through its modular design. It supports both outside-in tracking for structured environments (e.g., training facilities) and inside-out tracking using internal sensors for austere, field-based training lanes, making it adaptable to a wide variety of training scenarios.

4. Lack of Realism and Practical Training Value. The system simulated only the detector's handle using a plastic replica, which significantly deviated from the real operational equipment. This lack of realism made it difficult for operators to transfer their training to field conditions, as the weight, balance, and sensor feedback of the actual detector were missing. Consequently, trainees were unable to develop the necessary muscle memory or operational familiarity. By contrast, the present disclosure eliminates the problem by integrating directly with the actual field detector, whether by an attachable device or build into the detector itself. Trainees practice with the real equipment they will use in the field, allowing for seamless skill transfer and creating a highly realistic training experience.

5. Limited Scenario Flexibility and Engagement. The system was designed for a narrow set of scenarios and could not be easily adapted to simulate the diverse conditions that operators encounter in real-world environments. This lack of scenario flexibility, coupled with the absence of interactive elements such as gamification, limited the training system’s effectiveness and engagement for users of varying skill levels. By contrast, the present disclosure offers a dynamic, scenario-based training environment that is easily customizable to reflect different operational conditions, terrains, and threat profiles. The inclusion of gamification features, such as scoring, leaderboards, and adaptive challenges, promotes engagement, allowing trainees to continuously improve their skills while maintaining a high level of motivation.

Given these limitations, the prior device was ultimately deemed ineffective and was never adopted for widespread use. Today, most training for manual detectors is still conducted using traditional, instructor-led methods in physical training ranges. These methods rely heavily on subjective observations and lack the capability to provide real-time, objective feedback on the operator’s performance.

Therefore, as will be discussed in greater detail below, the present disclosure provides an interactive extended reality detector sweep trainer that addresses the significant gaps in current detector training methods. Current sweep trainer experimentation suggests up to 60% or more training time saved. In some implementations, it may provide a highly realistic, immersive training environment that uniquely integrates real field detector devices to allow trainees to practice using the exact equipment they will deploy in the field. This system may combine real-time, data-driven feedback on sweep techniques, including critical parameters such as detector head height, sweep speed, and lateral coverage, with advanced tracking technologies. This ensures that trainees can make immediate, informed adjustments to their technique, dramatically accelerating their learning curve and improving their operational proficiency.

Example features of the detector sweep trainer may include but are not limited to:

Real-Time Feedback. The system provides immediate, actionable feedback on critical operational parameters like detector head height, sweep speed, and detector angle, allowing operators to correct their technique instantly and practice in realistic, high-threat scenarios.

Integration with Real Equipment. By using the actual detector device, the system enables trainees to develop critical operational skills, seamlessly transferring their training into real-world missions with high accuracy and minimal adjustment.

Advanced Tracking Technologies. Supports both outside-in tracking, where external sensors capture precise detector movement, and inside-out tracking, where embedded gyroscopes and accelerometers track detector motion. The flexibility to switch between these modes ensures accurate training in both structured environments (e.g., a training facility) and austere field environments (e.g., remote operations).

Portable and Flexible Configuration. Whether in fixed training facilities or temporary, field-based training lanes, the system’s modular architecture allows it to adapt to various environments, ensuring operators receive realistic training in diverse operational scenarios.

Multi-User and Gamification Support. The system includes multi-user modes that allow trainees to participate in cooperative or competitive training scenarios. Operators can coordinate sweeps in large-area clearance missions or compete using scoring systems, leaderboards, and time-based challenges. These elements help trainees enhance both individual and team-based operational performance.

This example extended reality system may address the example shortcomings of previous attempts by providing an immersive, flexible, and highly practical training environment. The robust feedback mechanisms and adaptive configurations ensure that operators can develop and maintain the skills needed for high-probability detection in any operational setting, from demining to underground utility detection.

### System Overview

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium. These implementations may include advanced AI-enabled circuits, modules, or systems capable of dynamically adapting operations through predictive and prescriptive analytics, enhancing efficiency and decision-making across a wide range of applications.

Software may include artificial intelligence systems, which may include machine learning or other computational intelligence. For example, artificial intelligence (AI) may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, transformer-based architectures, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. Advanced AI tools such as large language models and hybrid neural networks enable nuanced decision-making, prescriptive scenario adjustments, and intelligent automation across training and operational contexts. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression based models, decision trees, hidden forests, Hidden Markov models, Bayesian models, genetic algorithms, large language models (LLMs), and other transformer-based architectures. In some implementations, the present disclosure may include combinations where an expert system uses one neural network for classifying an item and a different (or the same) neural network for predicting a state of the item, or employs hybrid approaches that integrate symbolic reasoning, rule-based engines, and AI models of various types to achieve desired outcomes.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage. Elements of the present disclosure may be represented by or encoded as non-fungible tokens (NFTs). Ownership rights related to the non-fungible tokens may be recorded in or referenced by a distributed ledger. Transactions initiated by or relevant to the present disclosure may use one or both of fiat currency and cryptocurrencies, examples of which include bitcoin and ether.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the "C" programming language, PASCAL, or similar programming languages, as well as in scripting languages such as JavaScript, PERL, or Python. The program code may execute entirely on the user's computer, partly on the user's computer, as a stand-alone software package, partly on the user’s computer and partly on a remote computer or entirely on the remote computer or server. In the latter scenario, the remote computer may be connected to the user’s computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), etc. may execute the computer readable program instructions/code by utilizing state information of the computer readable program instructions to personalize the electronic circuitry, in order to perform aspects of the present disclosure. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an artificial intelligence (AI) system-on-chip, a video processing system-on-chip, an organ-on-chip, a quantum algorithm system-on-chip, etc.

Examples of processing hardware may include, e.g., a central processing unit (CPU), a graphics processing unit (GPU), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an artificial intelligence (AI) co-processor.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These functions or operations may leverage AI-driven modules, including predictive analytics for insight generation and prescriptive analytics for scenario optimization, ensuring systems dynamically adapt to achieve targeted outcomes. These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

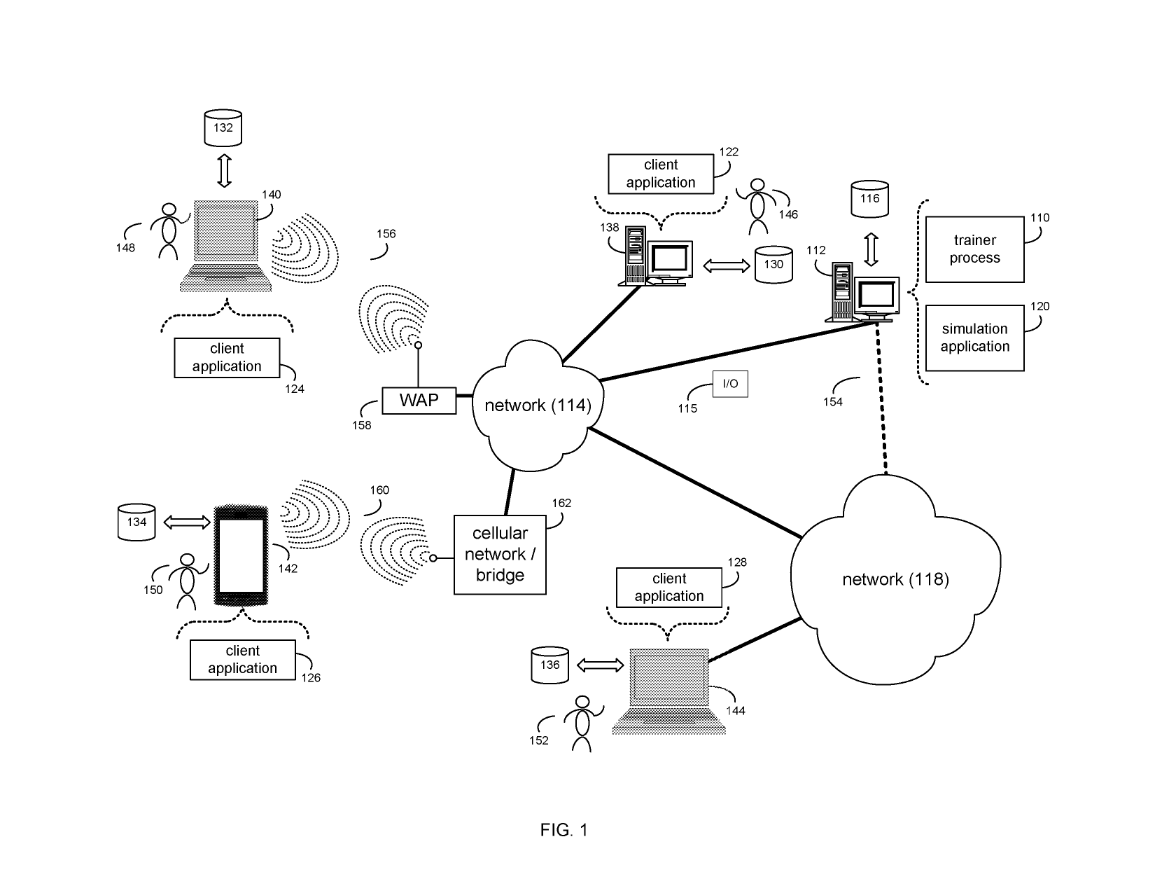

Referring now to the example implementation of FIG. 1, there is shown trainer process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the instruction sets and subroutines of trainer process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase telecommunications network facility, as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, trainer process 110 may be a component of the data store, a standalone application that interfaces with the above noted data store and/or an applet / application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a simulation application (e.g., simulation application 120), examples of which may include, but are not limited to, e.g., an automatic speech recognition (ASR) application, examples of which may include, but are not limited to, e.g., an ASR application (e.g., modeling, transcription, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a game training simulation system application, a virtual reality (VR) application, an extended reality (XR) application also known as mixed reality (MR), an augmented reality (AR) application, a virtual assistant (VA) application, a web conferencing application, a video conferencing application, a telephony application, a voice-over-IP application, a video-over-IP application, an Instant Messaging (IM)/"chat" application, a chatbot application, an interactive voice response (IVR) application, a short messaging service (SMS)/multimedia messaging service (MMS) application, a simulation feedback application, a training application, a real-world feedback application, or other application that allows for the simulation of or management of actual current real-world scenarios that can change in real-time based upon user input. In some implementations, trainer process 110 and/or simulation application 120 may be accessed via one or more of client applications 122, 124, 126, 128. In some implementations, trainer process 110 may be a standalone application, or may be an applet / application / script / extension that may interact with and/or be executed within simulation application 120, a component of simulation application 120, and/or one or more of client applications 122, 124, 126, 128. In some implementations, simulation application 120 may be a standalone application, or may be an applet / application / script / extension that may interact with and/or be executed within trainer process 110, a component of trainer process 110, and/or one or more of client applications 122, 124, 126, 128. In some implementations, one or more of client applications 122, 124, 126, 128 may be a standalone application, or may be an applet / application / script / extension that may interact with and/or be executed within and/or be a component of trainer process 110 and/or simulation application 120. Examples of client applications 122, 124, 126, 128 may include, but are not limited to, e.g., an ASR, examples of which may include, but are not limited to, e.g., an ASR application (e.g., modeling, transcription, etc.), a natural language understanding (NLU) application (e.g., machine learning, intent discovery, etc.), a text to speech (TTS) application (e.g., context awareness, learning, etc.), a speech signal enhancement (SSE) application (e.g., multi-zone processing/beamforming, noise suppression, etc.), a voice biometrics/wake-up-word processing application, a game training simulation system application, a web conferencing application, a video conferencing application, a telephony application, a voice-over-IP application, a video-over-IP application, an Instant Messaging (IM)/"chat" application, a chatbot application, an interactive voice response (IVR) application, a short messaging service (SMS)/multimedia messaging service (MMS) application, a feedback application, a training application, or other application that allows for the simulation of scenarios that can change in real-time based upon user input, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144. It will be appreciated after reading the present disclosure that simulation application 120 may similarly be applicable in non-simulation implementations, such as a use as a live Command and Control (C2) application and/or operating system.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a laptop computer (e.g., client electronic device 140), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), a wearable device (e.g., wearable headset), a virtual reality (VR) wearable, an extended reality (XR) mixed reality (MR) wearable, an augmented reality (AR) wearable, a connected foot-pedal device, a connected handheld pointing device, a biometric sensing device (e.g., an eye tracking sensor), a handheld detector, a dedicated network device, and combinations thereof. Client electronic devices 138, 140, 142, 144 may each execute an operating system, examples of which may include but are not limited to, AndroidTM, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of trainer process 110 (and vice versa). Accordingly, in some implementations, trainer process 110 may be a purely server-side application, a purely client-side application, or a hybrid server-side / client-side application that is cooperatively executed by one or more of client applications 122, 124, 126, 128 and/or trainer process 110.

In some implementations, one or more of client applications 122, 124, 126, 128 may be configured to effectuate some or all of the functionality of simulation application 120 (and vice versa). Accordingly, in some implementations, simulation application 120 may be a purely server-side application, a purely client-side application, or a hybrid server-side / client-side application that is cooperatively executed by one or more of client applications 122, 124, 126, 128 and/or simulation application 120. As one or more of client applications 122, 124, 126, 128, trainer process 110, and simulation application 120, taken singly or in any combination, may effectuate some or all of the same functionality, any description of effectuating such functionality via one or more of client applications 122, 124, 126, 128, trainer process 110, simulation application 120, or combination thereof, and any described interaction(s) between one or more of client applications 122, 124, 126, 128, trainer process 110, simulation application 120, or combination thereof to effectuate such functionality, should be taken as an example only and not to limit the scope of the disclosure.

In some implementations, one or more of users 146, 148, 150, 152 may access computer 112 and trainer process 110 (e.g., using one or more of client electronic devices 138, 140, 142, 144) directly through network 114 or through network 118. Further, computer 112 may be connected to network 114 through network 118, as illustrated with phantom link line 154. Trainer process 110 may include one or more user interfaces, such as browsers and textual or graphical user interfaces, through which users 146, 148, 150, 152 may access trainer process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11g, 802.11n, 802.11ac, Wi-Fi®, RFID, and/or Bluetooth^{TM} (including Bluetooth^{TM} Low Energy) or any device that is capable of establishing wireless communication channel 156 between client electronic device 140 and WAP 158. Client electronic device 142 is shown wirelessly coupled to network 114 via wireless communication channel 160 established between client electronic device 142 and cellular network / bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth^{TM} (including Bluetooth^{TM} Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

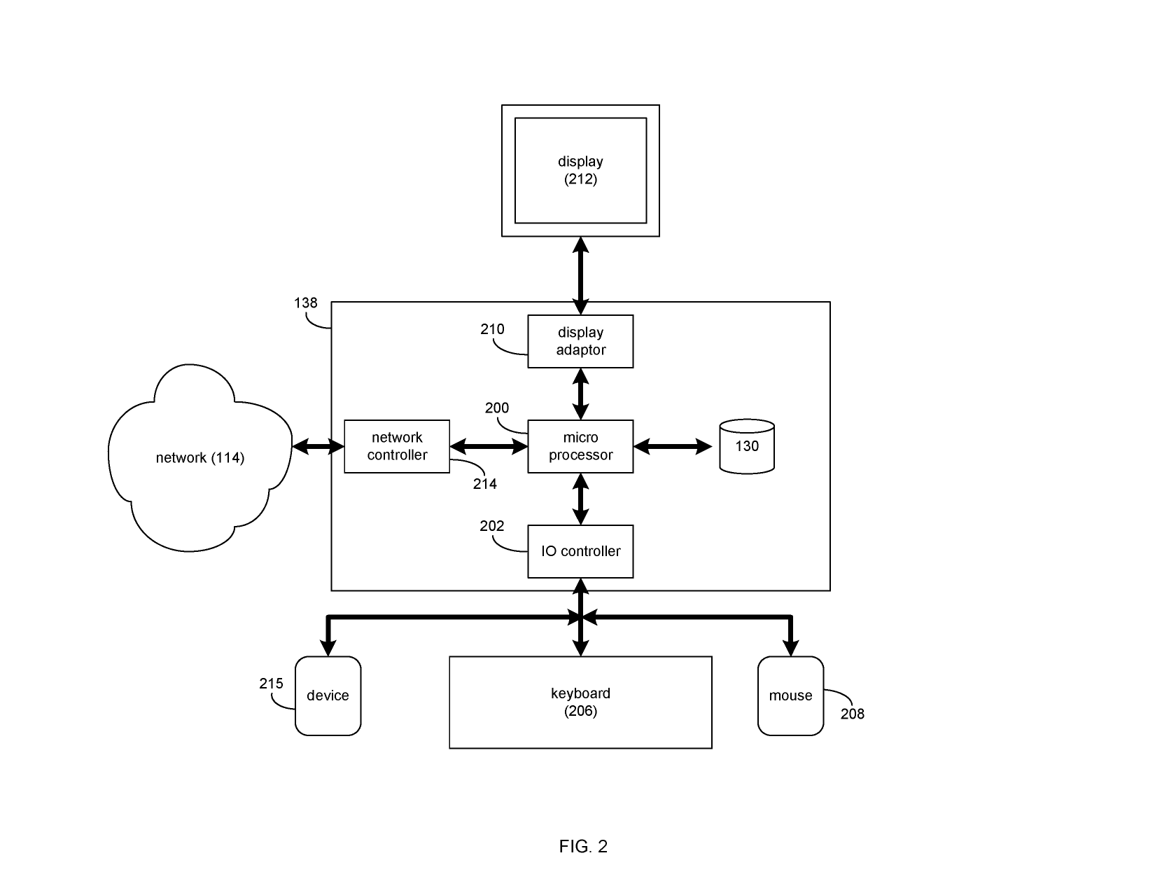

Referring also to the example implementation of FIG. 2, there is shown a diagrammatic view of client electronic device 138. While client electronic device 138 is shown in this figure, this is for example purposes only and is not intended to be a limitation of this disclosure, as other configurations are possible. Additionally, any computing device capable of executing, in whole or in part, trainer process 110 may be substituted for client electronic device 138 (in whole or in part) within FIG. 2, examples of which may include but are not limited to computer 112 and/or one or more of client electronic devices 138, 140, 142, 144.

In some implementations, client electronic device 138 may include a processor (e.g., microprocessor 200) configured to, e.g., process data and execute the above-noted code / instruction sets and subroutines. Microprocessor 200 may be coupled via a storage adaptor to the above-noted storage device(s) (e.g., storage device 130). An I/O controller (e.g., I/O controller 202) may be configured to couple microprocessor 200 with various devices (e.g., via wired or wireless connection), such as keyboard 206, pointing/selecting device (e.g., touchpad, touchscreen, mouse 208, etc.), scanner, custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to network 114 (e.g., the Internet or a local area network).

### The Trainer Process

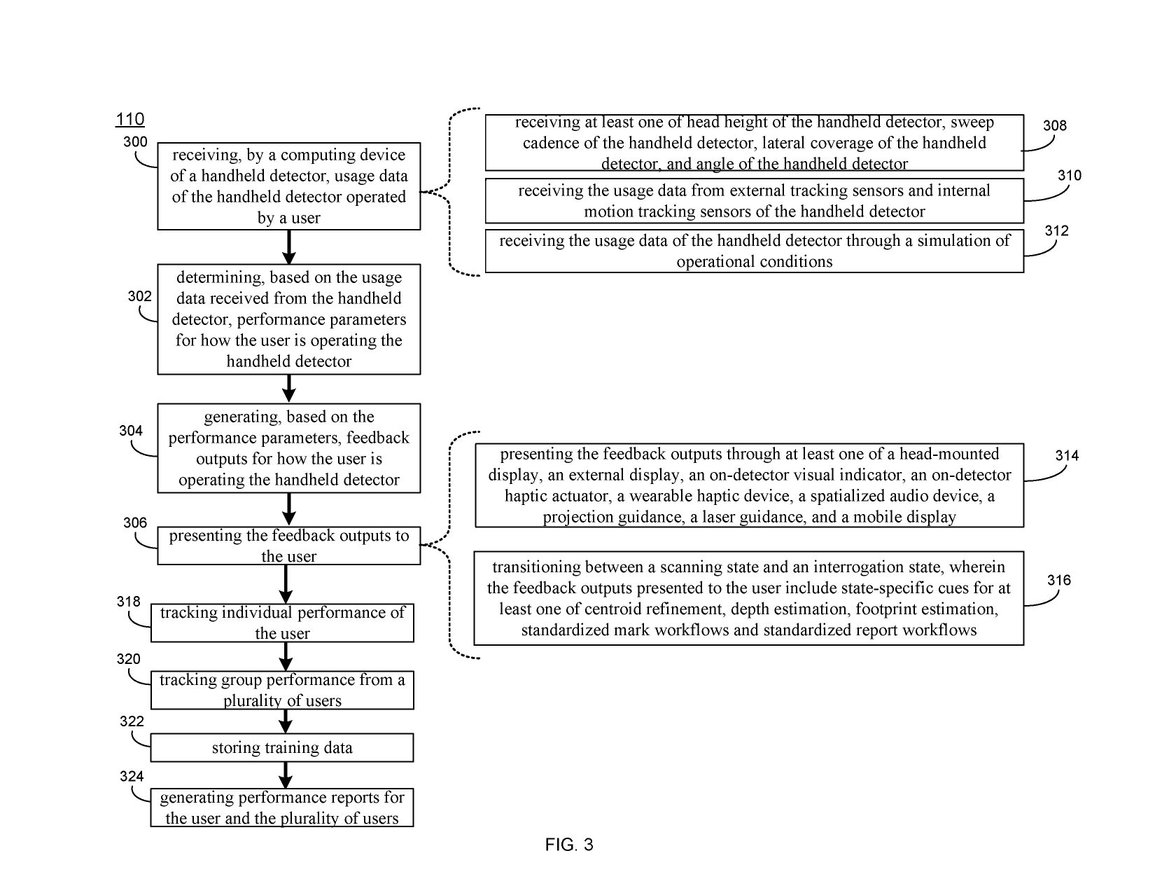

As discussed above and referring also at least to the example implementations of FIGS. 3-6, trainer process 110 may receive 300, by a computing device of a handheld detector, usage data of the handheld detector operated by a user. Trainer process 110 may determine 302 performance parameters for how the user is operating the handheld detector based on the usage data received from the handheld detector. Trainer process 110 may generate 304 feedback outputs for how the user is operating the handheld detector based on the performance parameters. Trainer process 110 may present 306 the feedback outputs to the user.

As will be discussed in greater detail below, the example interactive extended reality detector sweep trainer of trainer process 110 is an advanced training system designed to provide real-time feedback and immersive training environments for operators of manual detection equipment. The system integrates tracking technologies, data processing, and extended reality interfaces to create a highly realistic and interactive training experience, adaptable for use in various environments, including fixed training facilities, portable training lanes, and temporary field deployments. The system’s modular architecture and scalability enable it to support configurations ranging from small, single-user setups to large-scale, multi-user training environments, depending on training requirements and operational contexts.

In some implementations, the actual detector or at least a sufficiently similar replication may be used with the system. By utilizing the actual detector (or similar size, shape, and weighted replica) and delivering real-time feedback, trainer process 110 creates a level of training precision and operational readiness that has not been possible with prior solutions. This ensures operators are better equipped to detect targets more accurately and consistently across diverse, complex environments.

While the present disclosure is described using a metal detector (e.g., sweeper 400) as the tracking device, any appropriate manual detection equipment used by an operator (e.g., hand-held or ground-sweeping devices) may be used without departing from the scope of the present disclosure. For instance, a broad range of manual detection equipment may be used across military, commercial, research, and emergency applications. In military and humanitarian demining contexts, the system may be employed with handheld devices such as metal detectors, ground-penetrating radar (GPR) systems, dual-sensor mine detectors that combine metal and radar sensing (e.g., AN/PSS-14 or Minehound VMR3), portable magnetometers, and induction-based detectors used for locating unexploded ordnance or improvised explosive devices (IEDs). These types of detectors rely heavily on proper sweep speed, sensor height, and head angle, parameters that can be precisely monitored and corrected through the real-time feedback and tracking capabilities of the system.

In commercial and infrastructure maintenance environments, the trainer may be used with manual detectors such as electromagnetic induction pipe and cable locators, ground-penetrating radar utility scanners, acoustic or vibration-based leak detectors, magnetic locators for buried ferrous materials, and handheld rebar or stud detectors. These detectors are commonly used by utility technicians and construction personnel to identify underground utilities, cables, and pipelines, and they similarly benefit from training on consistent sweep techniques and spatial coverage.

For law enforcement and security operations, the system may be configured for training with handheld metal detectors or wands, portable contraband detectors using density or millimeter-wave sensing, radiation survey meters (e.g., Geiger counters or scintillation probes), and handheld explosive or chemical trace detectors such as ion-mobility spectrometers. The system’s ability to simulate realistic operational environments and deliver real-time performance metrics can help personnel maintain detection accuracy and situational awareness in field operations.

In archaeological and geological applications, the system may be paired with archaeological metal detectors, electromagnetic conductivity meters, GPR-based subsurface imaging devices, and fluxgate or proton magnetometers. These detectors are used to map buried artifacts, features, and geological structures, where subtle changes in detector response and handling technique can significantly influence detection quality.

For emergency management and search-and-rescue operations, the system may be integrated with handheld life detectors (e.g., ultrasound, seismic, or microwave motion sensors), thermal imaging detectors, gas detectors for hazardous leak detection, and portable radiation or chemical hazard sensors. By providing realistic scenario-based training with adaptive feedback, the system enables first responders to practice efficient and safe search techniques in simulated disaster conditions.

Additionally, in maritime and other specialized environments, the trainer may be used with handheld sonar devices, acoustic imaging tools, and magnetometers for underwater or shipboard inspection. The portable, standalone configuration of the system allows these use cases to be conducted even in confined or mobile settings, such as ships or aircraft.

Finally, the system may also support use with simulated or replica detectors designed specifically for training purposes. These may include inert or partially functional detector shells equipped with motion-tracking modules, inertial sensors, or mock sensor heads to replicate the weight, balance, and handling characteristics of real detectors. Such configurations allow basic sweep motion and coordination skills to be practiced safely while still benefiting from the real-time feedback and data analytics provided by the system. Therefore, the use of a metal detector as sweeper 400 should be taken as example only and not to otherwise limit the scope of the present disclosure.

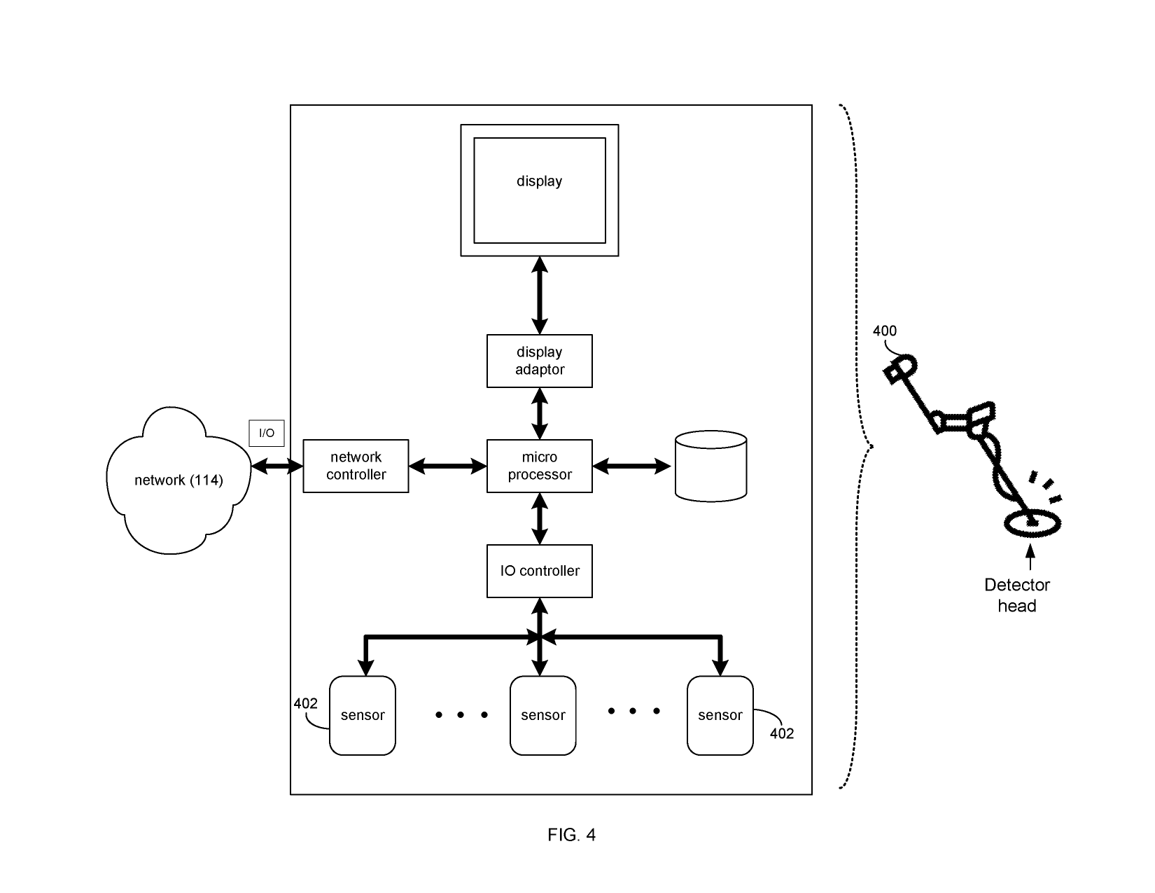

Referring at least to the example implementation of FIG. 4, an example of sweeper 400 is shown. In some embodiments, sweeper 400 represents the same handheld detector that an operator would use in real-world field operations, or a closely replicated training version having the same mass distribution, handle geometry, and sensor head configuration. By incorporating the actual field detector, or a replica with equivalent ergonomics, the training system allows the operator to develop authentic muscle memory, balance, and handling technique. While likely not as effective, a replica without equivalent ergonomics may also be used. As shown, sweeper 400 includes one or more onboard sensors 402 that communicate with a processing system to provide real-time data concerning detector motion, angle, and position. Each sensor 402 may be part of a distributed sensing network configured to monitor critical movement parameters such as sweep arc, height above ground, lateral velocity, and angular deviation. The data collected from sensors 402 are routed to the I/O controller shown in the system diagram of FIG. 4, which in turn relays the information to the microprocessor for processing, visualization, and feedback generation. In some implementations, trainer process 110 supports software-selectable detector profiles, thus, trainer process 110 can emulate or interface with multiple detector types (e.g., metal detectors, ground-penetrating radar units, or hybrid devices, etc.), allowing the training environment to dynamically match the operational detector being simulated.

In some implementations, sweeper 400 incorporates a detector-mounted sensor module, physically affixed to or integrated within the detector head. This module may include any suitable combination of inertial and/or magnetic sensing elements, such as accelerometers, gyroscopes, magnetometers, barometers, or visual odometry cameras, to enable high-precision, three-dimensional tracking of the detector’s position and orientation. By continuously capturing acceleration, angular rotation, and sweep pattern data, trainer process 110 provides a rich telemetry stream for evaluating detector handling performance. Trainer process 110 may also perform on-detector inertial dead-reckoning, estimating position and orientation directly from raw accelerometer and gyroscope data, optionally fused with magnetometer inputs and corrected for drift through techniques such as zero-velocity updates, gravity vector alignment, heading correction, or opportunistic visual/terrain beacon registration. Through this configuration, sweeper 400 can maintain accurate motion tracking even in the absence of external reference infrastructure. The resulting data flow, from sensor 402 to the I/O controller, through the microprocessor and display adaptor, and ultimately to the display interface, creates a closed feedback loop that provides trainees with immediate, data-driven guidance on sweep consistency, height, and coverage across a simulated training environment. As will be discussed below, the data may also be transmitted wirelessly or via a wired connection to other local and/or remote computing devices.

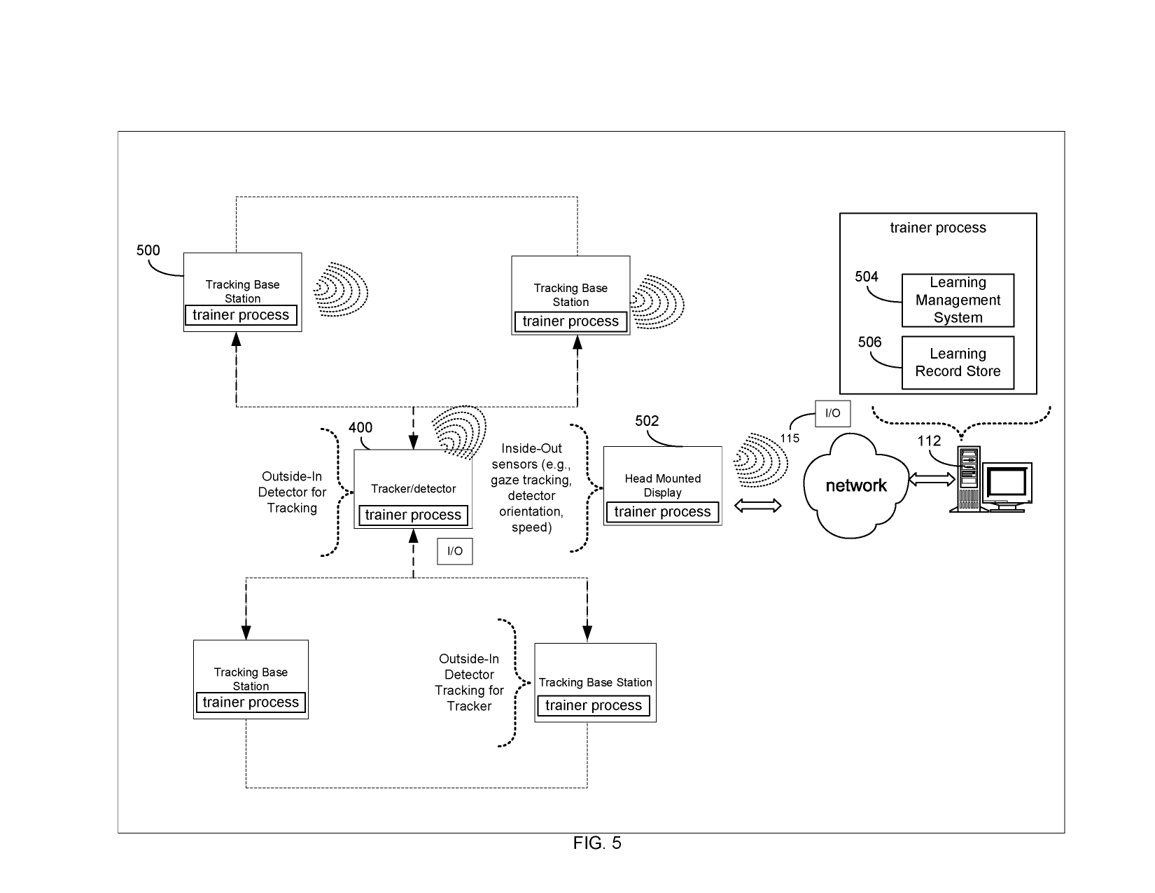

Referring also now to the example implementation of FIGS. 4 and 5, the interactive extended reality detector sweep trainer of trainer process 110 may include a distributed and modular system architecture that interconnects multiple hardware and software components to deliver real-time training feedback and analytics. When used together (optionally), the architecture unifies both the physical sensor ecosystem, embodied by sweeper 400, the detector-mounted sensors 402, and a plurality of tracking base stations 500, with higher-level computing and networking subsystems such as the central processing unit, network controller, learning management system (LMS) 504, and learning record store (LRS) 506. These elements cooperate through secure wired or wireless links, forming a closed feedback loop between the trainee’s detector motion, the tracking and feedback subsystems, and the visual and haptic feedback interfaces. Each component may function as an independent module that can be added or removed based on the training configuration, supporting both lightweight single-user setups and large, synchronized multi-user facilities.

In some implementations, the modular design allows the trainer system to be configured for a variety of operational contexts. As shown in FIG. 4, the core processing subsystem may include a microprocessor, I/O controller, display adaptor, and network controller, etc. which together handle data acquisition, computation, and possible visual output. In FIG. 5, this processing environment communicates bi-directionally with tracking base stations 500, head-mounted display (HMD) 502, and detector 400, all of which execute corresponding trainer process 110. Each trainer process may execute a node service responsible for local data pre-processing, synchronization, and timestamping before transmitting data to the central training software. This distributed configuration ensures low-latency synchronization across all subsystems, enabling accurate motion capture and instantaneous feedback to the operator.

In some implementations, one or more tracking base stations 500, as shown in FIG. 5, define an outside-in tracking zone that encompasses the trainee’s operating area. These external sensors may employ infrared (IR), structured light, radio frequency (RF), or optical tracking methods to triangulate the position and orientation of sweeper 400 in three-dimensional space. Each base station may operate as an independent time-synchronized node that continuously transmits its tracking data to the trainer process, which aggregates the readings to generate a high-fidelity motion model. The tracking density can be scaled up or down by adding/removing additional base stations to expand/reduce the coverage zone, ensuring precision even in small, large or complex environments. The outside-in configuration provides absolute positional data that can be fused with inside-out sensor data from the detector for redundancy and drift correction. It will be appreciated after reading the present disclosure that the tracking base stations may not be needed if sweeper 400 has all the sensors needed for gathering the appropriate information, but may add additional training information.

In some implementations, the central processing subsystem may act as the computational hub of trainer process 110. It may aggregate data from the network controller, I/O controller, and display adaptor, processing the combined sensor inputs in real time. Trainer process 110 running on this processor executes algorithms to derive key operational metrics such as sweep velocity, detector head height, angular deviation, and lateral coverage overlap. These algorithms may use real-time kinematic (RTK) corrections, Kalman filtering, or sensor fusion to integrate motion data from both outside-in base stations and inside-out inertial modules. Trainer process 110 may also manage simulation logic, scoring, environmental rendering, and feedback generation.

As further shown in FIG. 5, the processed data (e.g., via I/O 115) may be transmitted through a secure network to connected devices, including the HMD 502, handheld controllers, or external computing devices. The feedback loop transforms performance data into actionable guidance cues (e.g., visual, auditory, or haptic), allowing operators to immediately adjust their technique. Each detected deviation, such as excessive sweep height or uneven sweep rate, is mapped to a specific Feedback Indicator (FI) output channel according to a configurable cue-mapping policy. For example, a red overlay in the headset may indicate sweep height errors, a vibration pulse may indicate improper lateral coverage, and an audible tone may correspond to sweep speed. This flexible mapping ensures that identical logic can drive any available feedback interface.

In some implementations, trainer process 110 may include an Operator Feedback Subsystem (OFS) to provide a multi-modal interface between the trainee and trainer process 110, integrating the HMD 502 (or wearable feedback devices) and any detector-mounted feedback devices. The OFS may include a head-mounted display, wristband haptic motors, embedded vibration modules in the detector handle, auditory earpieces, or detector-mounted LEDs, etc. Each Feedback Interface (FI) in the OFS is capable of delivering real-time visual overlays, tone-based alerts, or haptic impulses proportional to the magnitude of a detected deviation. For instance, the head-mounted display may project augmented-reality alignment guides showing the optimal sweep arc, while detector-mounted LEDs indicate whether the head height is within tolerance. By providing continuous, context-specific feedback, the OFS accelerates learning and prevents reinforcement of improper techniques.

In some implementations, the components of trainer process 110 depicted in FIGS. 4 and 5 communicate through a secure wireless or wired network layer, which may consist of a self-contained mesh network, Wi-Fi router, or dedicated RF or BT/BTLE link. The network controller handles packet routing, quality-of-service management, and synchronization across all participating trainer processes. The network layer supports both local (LAN) and remote (WAN) configurations, enabling distributed training sessions across multiple facilities. In higher-load environments, compute-intensive processes, such as AI-driven analytics or real-time 3D visualization, may be offloaded to cloud-based or remote compute nodes, with summarized results returned to the local device for immediate display. This architecture ensures that even field-deployed, battery-powered setups maintain low latency and robust performance.

In some implementations, instructors may use handheld tablets or laptop control stations connected through the same network to monitor live trainee performance and control session parameters. These interfaces allow supervisors to instantiate training scenarios, adjust environmental conditions, modify difficulty levels, or trigger simulated threat objects in real time. The instructor’s dashboard may also display synchronized metrics such as sweep rate, coverage completeness, and positional deviation, along with live video or 3D renderings of the trainee’s motion. In multi-user environments, these control devices may act as master nodes coordinating data synchronization among all connected trainer processes.

In some implementations, external monitors or projection systems may be incorporated into the setup to display a “god’s-eye view” of the training lane, visualizing the sweeper’s 3D trajectory and the detected anomalies. These displays, which interface through the display adaptor of FIG. 4 or HMD 502, are especially useful for group instruction or after-action reviews (AARs). During live sessions, they can show overlaid performance traces or real-time heatmaps of coverage uniformity, providing both the trainee and instructor with intuitive situational awareness.

As shown in FIG. 5, training data and performance metrics may be transmitted via the network 115 to a Learning Management System (LMS) 504 and an associated Learning Record Store (LRS) 506. The LMS manages training session scheduling, user profiles, and course progress, while the LRS stores detailed, timestamped telemetry data compliant with xAPI or SCORM learning data standards. Together, they enable long-term performance tracking, trend analysis, and predictive modeling of trainee proficiency. Data can be synchronized across geographically distributed training centers, supporting enterprise-level analytics, accreditation, and adaptive curriculum generation.

In some implementations, austere or disconnected environments, such as aboard naval vessels, aircraft, or forward operating bases, trainer process 110 may be deployed as a self-contained standalone network. In this mode, the training environment operates independently of external infrastructure, with all data processing handled by the local CPU and storage. The network controller manages a closed-loop Wi-Fi, BT or mesh network linking the sweeper 400, the base stations 500, and the head-mounted display 502. Once connectivity to a broader enterprise network becomes available, locally stored session data and performance logs may be automatically synchronized with the LMS/LRS repositories (504, 506). This capability ensures continuous training readiness, even during transit or in isolated operational settings.

In some implementations, trainer process 110 supports a multi-user configuration in which two or more operators simultaneously train within the same virtual or hybrid physical-digital training environment. As shown conceptually in FIG. 5, each sweeper 400 and associated head-mounted display 502 operates as an independent network node running its own local trainer process. These trainer processes synchronize through the network and communicate with a central session host that governs timing, spatial registration, and event sequencing. Time synchronization may be maintained through Network Time Protocol (NTP), Precision Time Protocol (PTP), or GPS-disciplined oscillators to ensure sub-millisecond timestamp consistency across distributed nodes.

In some implementations, each participant’s position and orientation data are broadcast to all other participants using a lightweight message bus protocol such as MQTT, ROS 2 DDS, or WebRTC data channels. Trainer process 110 merges these data streams to produce a shared spatial reference frame, allowing each trainee’s sweeper and body position to be rendered in the others’ extended-reality (XR) view in real time. Within this configuration, operators can engage in cooperative sweeping missions, for example, staggered lateral formations for area clearance, or competitive scenarios, such as timed detection challenges or efficiency scoring exercises.

In some implementations, trainer process 110 automatically calculates inter-operator spacing, coverage overlap, and mutual occlusion zones, generating alerts when teams deviate from optimal spacing or when unscanned regions remain within the shared workspace. Instructors may assign team roles (e.g., primary detector, verifier, marker) and use the instructor console or LMS 504 to track both individual and group performance metrics such as detection rate, coverage efficiency, and false-positive ratio. Trainer process 110 multi-user architecture also allows instructors or observers to join a live session as “spectator clients” for monitoring, annotation, or intervention. In multi-facility deployments, geographically distributed users may participate in synchronized scenarios via the enterprise network, where cloud-based spatial mapping servers aggregate and broadcast positional data, enabling remote joint training exercises that maintain a unified operational picture.

In some implementations, following initial detection events, trainer process 110 may invoke a Target Interrogation and Localization Module (TILM) of trainer process 110, which provides guided workflows and real-time analytics to simulate post-detection procedures. This module extends beyond basic sweep tracking to replicate the fine-motor and procedural stages of confirming, classifying, and marking a target. In some implementations, the TILM of trainer process 110 leverages both inside-out sensors from the sweeper 400 and outside-in tracking data from the base stations 500 to compute a target centroid and probable spatial extent. Trainer process 110 then directs the trainee to conduct multi-pass cross-sweeps over the same region to refine localization accuracy and minimize false positives, and may dynamically evaluate the signal amplitude gradient and phase consistency between passes to estimate depth, target pose (angle/orientation), and confidence level, etc.

Trainer process 110 may emulate secondary detector tools, such as handheld pin-pointers or narrow-beam sensors, by adjusting the simulated field response curve and providing progressively narrower detection feedback. When sufficient data are collected, trainer process 110 may compute a depth and confidence score, displayable on the head-mounted display 502 as an overlaid heat map or AR bounding box, color-coded by probability density (e.g., green = likely clutter, amber = possible target, red = confirmed detection).

In some implementations, trainer process 110 may include target classification algorithms that may utilize stored feature signatures or synthetic training data to suggest object categories (e.g., metallic debris vs. ordnance casing). The operator receives visual, auditory, or haptic classification cues based on these probability models. Trainer process 110 can also prompt virtual marking actions, allowing the trainee to “place” an augmented-reality pin or flag within the XR scene, or to execute a physical mark using detector-mounted laser pointers, paint indicators, or connected marking modules.

To reinforce safety and procedural discipline, trainer process 110 may integrate Rules of Engagement (ROE) and Safety Gate protocols, configurable by the instructor. Before escalating to simulated probing or extraction, trainer process 110 may present the trainee with an interactive checklist requiring confirmation of situational steps such as re-sweep verification, environmental isolation, and peer confirmation. If a trainee attempts to bypass a safety gate, trainer process 110 may issue warnings or restricts progression until all prerequisites are met. All interaction events are logged in the LMS/LRS (504/506) for subsequent evaluation and certification tracking.

In some embodiments, trainer process 110 employs machine-learning-based sensor-fusion models that combine detector response data, inertial motion history, and terrain context to automatically propose optimal follow-up passes or to highlight probable false positives. The instructor may view these probability maps in real time, allowing coaching during the interrogation phase or after-action review.

In some implementations, trainer process 110 may be deployed and operated across a range of environments depending on mission requirements. As shown in FIGS. 4 and 5, the example system architecture supports both compact indoor setups, where external tracking sensors 500 define the training volume, and outdoor or expeditionary configurations that rely primarily on the detector’s inside-out tracking sensors 402. In an indoor facility, fixed tracking base stations may be mounted on tripods or wall brackets to create a calibrated coordinate system for high-precision motion capture. In outdoor or temporary field deployments, the same hardware can be reconfigured using battery-powered base stations and a self-contained network router, forming an ad-hoc mesh for localized tracking and communications.

In some implementations, each training session begins with environment initialization and spatial calibration, during which trainer process 110 establishes the global coordinate frame and registers the physical training area with its virtual counterpart. Once initialized, trainer process 110 automatically identifies the active detectors, HMDs, and base stations through network discovery and assigns them to a shared session ID. Calibration routines may involve sweeping a known calibration grid, aligning detected features to known reference points, or executing automated fiducial detection through visual markers placed around the training area. In some implementations, during active operation, the trainee’s motion and detector telemetry are continuously streamed to the microprocessor and/or broadcast through the network, where trainer process 110 evaluates the data in real time to generate feedback and scoring metrics. Environmental context parameters, such as terrain slope, surface composition, or electromagnetic interference models, may also be applied to adjust detection thresholds and feedback sensitivity dynamically.

The system’s scalability enables configurations ranging from single-trainee portable kits (including a single sweeper 400, one or two compact base stations 500, and a HMD 502) to large multi-lane facilities hosting numerous simultaneous trainees, each monitored through the LMS/LRS and unified instructor console. Regardless of deployment scale, the modular networking, calibration, and analytics pipeline ensures consistent performance metrics and feedback behavior across environments.

In some implementations, trainer process 110 is initially deployed by arranging a plurality of external tracking sensors or base stations (e.g., tracking base stations 500 in FIG. 5) around the perimeter of the intended training area when operating in the outside-in tracking mode. The number and spacing of these sensors may be determined by trainer process 110 setup utility, which computes the optimal geometry based on the expected sweep area dimensions, line-of-sight constraints, and desired spatial accuracy. Each tracking sensor may include a self-leveling mount and an integrated calibration beacon to facilitate rapid alignment. During setup, the sensors may emit synchronization pulses or optical fiducials to establish a common reference coordinate frame, ensuring that all positional data from individual sensors can be resolved into a unified three-dimensional (3D) world model.

Once the sensors are positioned, trainer process 110 may execute a calibration routine. The routine may be performed manually through a guided step-by-step process displayed on the instructor’s tablet or automatically using onboard calibration software of trainer process 110. Calibration may involve determining both the spatial boundaries of the sweep zone and the orientation alignment between the detector’s internal coordinate frame and that of the external tracking network. This process may include walking the detector through known waypoints, sweeping across fiducial markers placed on the ground, or using a handheld calibration wand with a built-in inertial measurement unit (IMU).

To achieve sub-centimeter precision, trainer process 110 may apply sensor-fusion algorithms such as extended or unscented Kalman filters that combine outside-in positional fixes with inside-out inertial data from the detector-mounted sensors 402. This fusion minimizes drift and corrects for transient occlusion events. In some embodiments, a bundle-adjustment optimization is executed after initial calibration to fine-tune base-station placement estimates and correct for minor deviations in sensor pitch, yaw, or elevation.

In some implementations, following environmental calibration, each trainee performs a detector alignment sequence to register their individual device and viewpoint within the established tracking zone. With the XR headset (HMD 502) powered on, trainer process 110 projects a virtual calibration grid or holographic markers corresponding to the physical environment. The trainee moves the detector through a series of guided poses, such as level sweeps, tilts, and lateral arcs, while trainer process 110 measures correspondence between real and virtual motion. The calibration software of trainer process 110 computes the rigid-body transform that aligns the detector’s internal IMU reference frame with the global coordinate system.

In some implementations, eye-tracking sensors within HMD 502 measure the operator’s line of sight to verify visual-spatial alignment, ensuring that virtual overlays (e.g., height indicators or sweep-coverage guides) appear anchored correctly to real-world surfaces. Once alignment is validated, trainer process 110 stores a user-specific calibration profile linked to the trainee’s LMS 504 record, enabling rapid re-initialization in future sessions. For portable or standalone configurations, calibration data may be cached locally on the detector’s embedded microcontroller or exported to removable media to support fully disconnected operation.

In some implementations, for portable or austere deployments, trainer process 110 may enter a standalone network configuration. In this mode, all components, including detector 400, one or more local tracking beacons (tracking base stations 500), and HMD 502, communicate over an ad-hoc wireless mesh hosted by the system’s onboard network controller. The calibration sequence may then rely primarily on inside-out tracking methods using the detector’s own inertial and visual sensors. Automatic calibration routines may leverage environmental cues such as terrain features, compass heading, or gravitational vectors to infer absolute orientation without external references. This ensures the training system remains operational even when deployed in remote, GPS-denied, or infrastructure-limited settings.

In some implementations, after calibration is complete, trainer process 110 is launched and loads the selected training scenario from the LMS 504 or a local configuration file. Trainer process 110 initializes the data streams from the detector-mounted sensors 402, tracking base stations 500, and HMD 502, verifying synchronization and latency thresholds. Once all subsystems are confirmed as stable, the trainee begins the session by performing detection sweeps within the virtualized training lane.

Trainer process 110 continuously captures and fuses motion, positional, and detector telemetry data to compute a set of key performance indicators (KPIs) in real time. These include, for example, detector head height, sweep velocity, lateral coverage uniformity, and angular consistency. Threshold values and performance tolerances for these KPIs are pre-configured per scenario but may also adapt dynamically through AI-driven parameter tuning based on historical trainee performance.

In some implementations, during each sweep cycle, trainer process 110 measures multiple independent parameters, including but not limited to:

Detector head height above the ground: calculated from fused positional data between the detector and ground-plane references;

Sweep speed and consistency: derived from temporal displacement of the detector head’s centroid path;

Forward progression and coverage area: determined by integrating lateral sweep width over time to estimate percentage coverage; and

Detector orientation and angle: resolved from quaternion data supplied by the IMU and corrected via magnetometer heading stabilization.

Each parameter is normalized against its respective target range and mapped to a feedback profile that defines acceptable, warning, and error zones. These profiles are stored as part of the feedback-mapping library, allowing instructors to standardize training evaluation criteria across sessions.

In some implementations, as the trainee performs the detection task, OFS of trainer process 110 provides instantaneous cues through the designated Feedback Indicators (FIs). For example, HMD 502 may project color-coded alignment bars indicating whether the detector head height is within tolerance (green), approaching a limit (yellow), or exceeding it (red). Simultaneously, the detector handle may emit a corresponding haptic pulse pattern, and a brief auditory cue may signal the magnitude of the deviation.

Trainer process 110 may include an adaptive feedback engine to evaluate rolling averages of KPI deviations and applies weighted smoothing functions to prevent over-correction from transient fluctuations. When persistent errors are detected, such as consistently high sweep speed or incomplete coverage, trainer process 110 escalates to a predictive guidance mode that proactively suggests corrective adjustments via on-screen arrows, ghost-trail trajectories, or verbal instructions delivered through the headset audio channel. The instructor’s tablet or console interface receives mirrored telemetry streams, enabling real-time oversight and manual feedback if desired. All performance data are timestamped and logged to the LMS/LRS for post-session analytics, trend visualization, and automated proficiency scoring.

In some implementations, trainer process 110 may receive 300, by a computing device of a handheld detector, usage data of the handheld detector (e.g., sweeper 400) operated by a user. For instance, in the context of the interactive extended-reality detector sweep trainer, this operation enables trainer process 110 to capture and analyze real-time operational data directly from sweeper 400 that the trainee manipulates during the training session. The usage data may include, for example, motion telemetry, sweep velocity, detector head height, angular position, and activation events corresponding to simulated detections. By acquiring these data directly from the actual detector (or a functional equivalent), trainer process 110 ensures that every feedback metric reflects true physical handling, thereby aligning training outcomes with real-world operational behavior. This approach eliminates the abstraction gap that existed in prior surrogate-based systems and allows training results to map precisely onto field performance.

In some implementations, as noted above, the handheld detector (e.g., sweeper 400) includes a microprocessor, I/O controller, and sensor array configured to transmit operational parameters to trainer process 110. The detector’s internal electronics may be interfaced through a secure wireless or wired data link (e.g., Bluetooth Low Energy, Wi-Fi Direct, or USB-C connection) to the training software of trainer process 110 that may also be running on a host computing device. The transmitted data may include time-stamped motion vectors, signal amplitudes, and detector state flags (e.g., coil activation, ground balance, or sensitivity setting). This configuration allows trainer process 110 to analyze the user’s physical technique in real time and generate adaptive feedback through the Operator Feedback Subsystem (OFS).

In some implementations, usage data may be captured via the detector-mounted sensor module affixed to or integrated with the detector head. The sensor module may include accelerometers, gyroscopes, magnetometers, and environmental sensors that collectively generate a 6-DoF motion profile of the detector’s sweep. Trainer process 110 may locally preprocess the sensor data using inertial dead-reckoning or sensor fusion algorithms before transmitting compressed telemetry packets to other portions of trainer process 110 for further interpretation. This implementation ensures low-latency operation even in portable or standalone network modes and allows for seamless data capture across various detector types and training environments.

In some implementations, the received usage data are normalized according to a unified detector data model maintained by trainer process 110. This model enables the training software to interpret detector telemetry from any supported detector make or model through a standardized parameter set (e.g., sweep arc, head height variance, and angular stability index). Trainer process 110 may apply AI-based analytics to correlate the usage data with performance metrics and detect behavioral patterns, such as consistent over-sweeping, incomplete coverage, or improper posture. By analyzing real detector telemetry rather than simulated approximations, the trainer process produces accurate performance diagnostics that directly translate to improved real-world detection proficiency.

In some implementations, trainer process 110 integrates seamlessly with the actual field detector, allowing trainees to practice using the same equipment they will operate during real-world missions. This seamless integration creates an unbroken continuum between the training environment and operational deployment. Because the physical characteristics, weight, balance, and sensor feedback of the field detector are preserved, the trainee develops authentic muscle memory and tactile familiarity. The resulting realism strengthens neural patterning for motion control and perception, ensuring that habits formed during training are directly transferrable to mission conditions.

In some embodiments, trainer process 110 employs a modular software interface layer that communicates with multiple detector hardware protocols. This allows the training software to recognize and adapt to various detector architectures, such as electromagnetic induction, ground-penetrating radar (GPR), or magnetometer-based devices, without modifying the core trainer code. Detector-specific configuration profiles stored in a local database define communication parameters (e.g., sampling rates, sensor ranges, and event triggers), enabling plug-and-play integration for different detector families.

In some implementations, trainer process 110 dynamically synchronizes the detector’s physical position and motion with the trainee’s XR headset (HMD 502), ensuring precise alignment between real-world actions and virtual overlays. For instance, when the trainee lowers the detector head toward the ground, the corresponding XR display may show a digital elevation indicator that reflects true spatial orientation. This alignment is maintained through a real-time sensor fusion loop linking the detector’s IMU data to the headset’s inside-out tracking system, providing the operator with visually and kinesthetically consistent feedback.

In certain implementations, the same detector may transition seamlessly between “training mode” and “operational mode.” In training mode, the detector’s telemetry is intercepted by the trainer process 110 for feedback generation, while in operational mode, the detector functions normally for live field detection. This dual-mode capability allows the same hardware to serve both as a training instrument and a deployable operational device. As a result, operators maintain continuity of device familiarity from training to mission execution, eliminating the need for reorientation when switching contexts.

In some implementations, receiving the usage data of the handheld detector may include receiving 308 at least one of head height of the handheld detector, sweep cadence of the handheld detector, lateral coverage of the handheld detector, and angle of the handheld detector. For instance, this capability allows trainer process 110 to capture and interpret key biomechanical and positional parameters that determine effective detector operation. Real-time measurement of these variables enables the trainer software to analyze the trainee’s motion with precision comparable to laboratory-grade motion-capture systems but in a portable, field-deployable form factor. By continuously receiving detector telemetry, including head height, sweep cadence, lateral coverage, and angular displacement, trainer process 110 constructs a dynamic motion profile of each operator. This continuous stream of quantitative data enables the feedback engine to identify inefficient techniques as they occur and to guide the trainee toward optimal sweep mechanics, dramatically accelerating learning and improving detection reliability.

In some implementations, the detector-mounted sensor module (e.g., sensor 402) includes an altimetric or distance-sensing component, such as an infrared rangefinder, ultrasonic transducer, or downward-facing LiDAR element, configured to measure the detector head’s instantaneous height above ground. The readings are fused with inertial data from the accelerometer and gyroscope to produce a stabilized vertical displacement metric. Trainer process 110 compares this value against a stored target range for the selected detector model and issues immediate feedback through the Operator Feedback Subsystem (OFS). For example, if the detector head height deviates by more than a predefined tolerance, HMD 502 may display a colored height bar while the detector handle emits a short vibration pulse or sound to prompt corrective motion.

In some implementations, trainer process 110 calculates sweep cadence (i.e., cycles per second) by analyzing lateral motion vectors derived from sequential positional samples. Trainer process 110 may apply a moving-window Fourier or zero-crossing analysis to determine rhythmic stability and identify tempo drift. Simultaneously, trainer process 110 integrates the detector head’s instantaneous position over time to compute total lateral coverage, providing a quantitative measure of how uniformly the ground area has been scanned. Instructors may view these results as a two-dimensional heat map projected on an external display or as an augmented overlay within the trainee’s headset. This analysis helps identify underswept or overswept regions, allowing operators to immediately adjust spacing and motion rhythm.

In some implementations, the angular orientation of the handheld detector is derived from a quaternion output generated by the onboard IMU within the detector-mounted sensor module. Trainer process 110 calculates both pitch (front-to-back tilt) and roll (side-to-side tilt) to determine whether the detector head maintains proper coupling with the ground surface. Trainer process 110 applies real-time thresholds for each axis and interprets angular deviations as potential lift-offs or improper scanning posture, and when deviations exceed tolerance, trainer process 110 triggers context-aware feedback cues, such as a directional arrow in the headset display or a short-tone gradient corresponding to the degree of misalignment.

In some implementations, trainer process 110 performs multi-parameter fusion by combining head height, sweep cadence, lateral coverage, and angular data into a composite technique quality index (TQI). The TQI quantifies the overall consistency and proficiency of each sweep, allowing the feedback system of trainer process 110 to adapt its sensitivity dynamically. For instance, if the trainee demonstrates stable cadence but inconsistent head height, trainer process 110 automatically de-emphasizes cadence feedback and intensifies head-height guidance. This adaptive weighting ensures that feedback remains relevant and non-overwhelming, preventing cognitive overload while optimizing motor learning efficiency.

In some implementations, receiving the usage data of the handheld detector may include receiving 310 the usage data from external tracking sensors and internal motion tracking sensors of the handheld detector. For instance, this configuration enables simultaneous or selectable use of both external and internal motion-tracking systems of trainer process 110 to ensure continuous, high-precision monitoring of detector movement under varying environmental and logistical conditions. The dual-mode tracking framework, combining outside-in and inside-out modalities, allows trainer process 110 to maintain positional and orientational fidelity across both controlled training facilities and remote field operations. Trainer process 110 fuses data from these two complementary sources to produce an accurate and example six-degree-of-freedom (6-DoF) spatial model of the detector’s trajectory, head height, and sweep pattern. This multi-source redundancy not only mitigates data dropouts caused by occlusions or magnetic interference but also ensures consistent feedback accuracy even in degraded conditions, achieving a level of reliability that prior single-source training systems could not match.

In some implementations, outside-in tracking is achieved using a network of external tracking sensors (e.g., base stations 500) arranged around the training area perimeter. Each base station may emit optical, infrared, radio-frequency (RF), or structured-light signals used to triangulate the position and orientation of the handheld detector (e.g., sweeper 400). The base stations may operate in a synchronized frame, either through direct timing cables or via wireless clock synchronization protocols such as Precision Time Protocol (PTP). Positional data are transmitted to trainer process 110, which calculates the detector’s real-time spatial coordinates and rotational quaternions. Outside-in tracking is optimized for structured indoor facilities, where consistent line-of-sight between the detector and base stations can be maintained to achieve sub-centimeter accuracy.

In some implementations, sweeper 400 integrates an onboard sensor 402 that provides inside-out motion tracking using one or more inertial and magnetic sensors such as accelerometers, gyroscopes, magnetometers, or barometric altimeters. The onboard microcontroller executes sensor-fusion algorithms (e.g., complementary or Kalman filters) to compute real-time position and orientation estimates without external references. Inside-out tracking enables trainer process 110 to function in austere or mobile environments, such as open fields, disaster sites, or maritime vessels, where external sensors cannot be deployed. Sensor 402 may also include an onboard visual odometry camera or photometric sensor that detects terrain motion relative to the detector head, providing additional spatial cues for position correction during long-duration sessions.

In some implementations, trainer process 110 employs a sensor-fusion engine to merge inside-out and outside-in tracking data into a single continuous motion stream. The fusion engine performs real-time weighting of data sources based on confidence metrics (e.g., signal-to-noise ratio, drift estimate, or occlusion probability). When outside-in visibility is optimal, the external base stations dominate positional estimation; when occlusions occur or when operating in standalone mode, trainer process 110 transitions smoothly to inertial-based inside-out estimation. Cross-calibration between the two systems may be maintained through automatic re-alignment routines that match shared reference points, such as floor-plane detection or gravity vector orientation.

In some implementations, trainer process 110 dynamically selects the most appropriate tracking mode based on operational context and environmental characteristics. For example, when deployed in a fixed training facility, trainer process 110 may automatically initialize outside-in tracking for precision motion capture. Conversely, when trainer process 110 detects the absence of base station signals or a network bandwidth constraint, it activates inside-out tracking for self-contained operation. The adaptive controller may also employ AI-based environment classification to optimize mode switching, ensuring minimal latency and error accumulation. This capability allows seamless continuity of data acquisition even when trainees move between indoor and outdoor training zones, ensuring uninterrupted real-time feedback and consistent data fidelity.

In some embodiments, both inside-out and outside-in telemetry streams are normalized within the system’s data pipeline before being stored in the Learning Management System (LMS 504) and Learning Record Store (LRS 506). The unified data format preserves per-frame metadata, including timestamp, positional uncertainty, and source origin (internal vs. external). During post-training analysis, instructors can visualize both tracking modalities overlaid on the same 3D trajectory to assess sensor agreement and quantify performance accuracy. This integration not only enhances real-time feedback reliability but also enriches post-session analytics and predictive modeling.

In some implementations, receiving the usage data of the handheld detector may include receiving 312 the usage data of the handheld detector through a simulation of operational conditions. For instance, simulated operational conditions enable trainees to experience realistic mission scenarios that replicate the environmental, spatial, and sensory complexities of real-world detection tasks. Rather than merely recording detector motion in isolation, trainer process 110 generates immersive, data-rich virtual environments that dynamically influence the feedback loop and detector behavior. These simulated conditions may reflect soil density, terrain gradient, ambient electromagnetic interference, or clutter density, each of which affects sensor responsiveness and signal interpretation. By merging this environmental simulation with the detector’s live telemetry, trainer process 110 produces usage data that mirror field conditions, allowing operators to refine their technique under mission-accurate constraints. The inclusion of adaptive gamification mechanisms, such as real-time scoring, rank progression, and cooperative or competitive modes, adds measurable incentives for skill development and engagement, ensuring trainees not only learn effectively but remain motivated through structured performance challenges.

In some implementations, trainer process 110 models the physical interactions between the detector and the surrounding virtual terrain. Trainer process 110 adjusts virtual response signals according to terrain parameters such as soil conductivity, moisture level, density, and surface irregularity. For instance, sweeping over a simulated sandy environment may produce weaker or more diffuse detection responses, while clay-rich terrain may amplify return signals but introduce noise. These characteristics are parameterized through configurable datasets stored in the system’s scenario database. During a session, trainer process 110 injects terrain-specific distortion factors into the detector’s signal simulation, allowing the trainer to generate realistic feedback under a variety of geological and climatic conditions.

In some implementations, simulated targets (e.g., buried mines, metallic artifacts, or utility lines) are defined by 3D spatial coordinates and material property profiles stored in the system’s scenario library. Each target’s response signature, amplitude, phase, and decay rate, is algorithmically generated based on its simulated material composition, burial depth, and orientation. Trainer process 110 dynamically adapts these parameters as the trainee’s detector approaches, producing real-time response variations consistent with realistic sensor behavior. Adaptive modeling may also simulate environmental interference such as overlapping signals from adjacent clutter, metallic debris, or cross-talk between detectors in multi-user sessions. The trainer process logs each detection event, correlating simulated target data with actual sweep parameters to calculate precision metrics such as detection latency, sweep-to-detection ratio, and false-positive rate.

In some implementations, trainer process 110 adjusts performance parameters, such as acceptable head height range, sweep cadence, and angular tolerance, based on the simulated operational environment. For example, in uneven or sloped terrain simulations, angular thresholds may be relaxed to account for changing elevation, whereas in urban scenarios, head height limits may be tightened for precision near surface utilities. Trainer process 110 may automatically modify these tolerances during runtime to maintain realism and prevent the trainee from optimizing solely for ideal laboratory conditions. As usage data are received, trainer process 110 associates each data sample with its corresponding simulated environmental parameters, forming a composite dataset that accurately represents both user behavior and scenario context.

In some implementations, trainer process 110 includes a gamification engine that overlays competitive and motivational elements onto the training process. The gamification engine assigns performance scores based on quantitative metrics such as coverage efficiency, sweep consistency, false-alarm rate, and reaction time to simulated detections. A scoring algorithm may normalize results against scenario difficulty and environmental complexity, generating an objective measure of skill progression. Leaderboards, ranking badges, and timed challenges may be presented through HMD 502 or instructor display, encouraging engagement and repeat training. In multi-user configurations, synchronized scoring protocols allow trainees to participate in cooperative missions, where team success depends on collective coverage, or competitive modes, where individuals compete for the highest accuracy or efficiency scores.

In some implementations, trainer process 110 employs an AI-based adaptive learning module that modifies future scenarios based on prior trainee performance. If the trainee demonstrates proficiency under current environmental conditions, trainer process 110 automatically increases scenario complexity, introducing additional clutter, tighter timing constraints, or reduced signal clarity. Conversely, if the trainee exhibits repeated errors (e.g., maintaining improper sweep height or inconsistent coverage), trainer process 110 may present simplified conditions with enhanced visual cues to reinforce fundamental technique. This adaptive progression allows trainer process 110 to tailor difficulty dynamically, optimizing cognitive load and accelerating skill acquisition. Scenario data and corresponding performance results are stored within LMS 504 and LRS 506, allowing instructors to monitor progression trends and design personalized training paths.

In some implementations, trainer process 110 may determine 302 performance parameters for how the user is operating the handheld detector based on the usage data received from the handheld detector. For instance, this process enables real-time and retrospective evaluation of how each operator handles their detector in relation to predefined optimal performance metrics. Trainer process 110 analyzes continuous usage data streams, such as detector head height, sweep cadence, angular stability, and lateral coverage, to derive quantitative performance parameters reflecting user proficiency and adherence to best-practice sweep mechanics. Because trainer process 110 is designed to integrate seamlessly with multiple detector types and sensor configurations, the same analytical framework can evaluate performance regardless of whether the operator uses a metal detector, ground-penetrating radar (GPR) unit, or hybrid multi-sensor device. The universality of this approach may be derived from trainer process 110’s ability to automatically adapt internal tolerances, calibration constants, and feedback thresholds based on the chosen detector profile. Once these parameters are established, the trainer process translates them into actionable insights, delivering real-time feedback through visual, auditory, or haptic channels and generating long-term trend data for adaptive learning and predictive analytics.

In some implementations, trainer process 110 incorporates a detector abstraction layer within trainer process 110 that maps raw telemetry from diverse detector hardware into a standardized data model. When a specific detector type is selected from the interface, the abstraction layer loads the appropriate configuration file containing calibration coefficients, sensor latency compensation factors, and performance thresholds. This enables the same feedback algorithms and visualization modules to operate across multiple detector platforms without modification. For example, when configured for a GPR detector, trainer process 110 interprets vertical oscillations differently than when configured for an electromagnetic induction detector, ensuring accurate height and coverage assessments in both cases.

In some implementations, trainer process 110 tailors the Operator Feedback Subsystem (OFS) outputs to the detector’s operating characteristics and the trainee’s current performance parameters. Feedback may be presented through any combination of extended-reality overlays in HMD 502, on-detector display indicators, audio tones, or haptic actuators embedded in the detector handle. The feedback engine of trainer process 110 assigns each parameter, such as sweep rate variance or head-height deviation, a response modality optimized for immediacy and clarity. For instance, an out-of-tolerance head height may trigger a vibration pulse, while angular misalignment produces an audible pitch shift proportional to the degree of error. Because all feedback channels are software-defined, trainer process 110 can re-map indicators for accessibility, instructor preference, or environmental noise conditions.

In some implementations, trainer process 110 continuously computes derived metrics from raw telemetry, including sweep efficiency, stability index, rhythm uniformity, and detection-response accuracy. These parameters are aggregated into a composite Performance Quality Index (PQI) that quantifies overall operational proficiency. The PQI may be visualized on the trainee’s HMD 502 or logged to the Learning Management System (LMS 504) for post-session analysis. Instructors can use these data to identify common technique deficiencies across cohorts or to evaluate training-curriculum effectiveness. Trainer process 110 may further normalize parameters according to environmental context (e.g., simulated terrain roughness or interference density) to ensure fair comparison across scenarios.

In some implementations, data collected across multiple training sessions are processed using machine-learning models of trainer process 110 that identify correlations between operator behavior and detection outcomes. Trainer process 110 may employ regression analysis, neural networks, or reinforcement-learning agents to predict detection probability, coverage efficiency, or false-alarm likelihood under given operating conditions. These predictive models enable real-time coaching, where trainer process 110 anticipates emerging performance trends and delivers corrective guidance before errors compound. Over longer timescales, predictive analytics support training program optimization by highlighting which parameters most strongly influence success. For example, analysis may reveal that marginally faster sweep cadences yield no degradation in coverage, or that reduced overlap thresholds maintain detection probability, insights that can inform detector-design improvements and updated field procedures.

In some implementations, the predictive models are extended to perform aptitude assessment across individual and team datasets. By analyzing temporal improvement curves and consistency factors, trainer process 110 can automatically classify operators according to skill tier, learning rate, and attention to corrective feedback. These classifications are logged to the LMS/LRS (504/506) and presented through instructor dashboards to identify trainees requiring additional focus or remedial exercises. At the organizational level, aggregated data allow administrators to evaluate training throughput, equipment utilization efficiency, and mission readiness metrics.

In certain embodiments, insights generated from predictive analytics are fed back into the detector trainer’s control algorithms of trainer process 110 to continuously refine performance evaluation thresholds and scenario difficulty. When predictive models indicate that a given detector configuration consistently produces above-average results under specific conditions, trainer process 110 automatically recalibrates sensitivity margins or modifies scoring weightings to maintain appropriate challenge levels. This closed-loop optimization ensures that both the hardware and software components of the training ecosystem evolve in response to empirical data, creating a self-improving framework for detector training, evaluation, and operational readiness.

In some implementations, trainer process 110 may generate 304 feedback outputs for how the user is operating the handheld detector based on the performance parameters, and in some implementations, trainer process 110 may present 306 the feedback outputs to the user (wherein presenting the feedback outputs to the user may include presenting 314 the feedback outputs through at least one of a head-mounted display, an external display, an on-detector visual indicator, an on-detector haptic actuator, a wearable haptic device, a spatialized audio device, a projection guidance, a laser guidance, and a mobile display). For instance, trainer process 110 transforms the real-time performance parameters derived from detector telemetry into singular or multi-modal feedback outputs delivered through an Operator Feedback Subsystem (OFS) of trainer process 110. The OFS acts as a closed-loop guidance interface that continuously informs the trainee how the handheld detector is being operated relative to optimal sweep behavior. By mapping specific deviations, such as excessive head height, off-angle orientation, or inconsistent sweep cadence, to intuitive visual, haptic, and auditory cues, the system allows operators to correct technique instantaneously. This real-time, data-driven feedback replaces traditional instructor observation with objective, measurable guidance, enabling faster skill acquisition and uniform training quality across individuals and environments.

In some implementations, the same infrastructure can also operate during live field missions when embedded within operational detectors, allowing personnel to receive unobtrusive performance cues without interrupting detection tasks. Switching between training mode and operational mode enables a seamless continuum from practice to deployment, preserving muscle memory and consistent handling under real-world conditions.

In some implementations, a hands-free, HMD 502 projects augmented-reality (AR) or mixed-reality (MR) overlays directly within the operator’s field of view. The interface may display real-time symbology such as detector head height bars, lateral-coverage traces, or alignment arrows, along with textual or icon-based prompts. Spatialized graphics can highlight simulated or detected targets, show sweep boundaries, and warn when key parameters exceed tolerance. Audio and haptic signals may be co-presented through the headset for multi-sensory reinforcement while maintaining full situational awareness.

In some implementations, one or more visual indicators integrated into the detector (e.g., LED light bars around the detector head, color-changing rings, shaft-mounted micro-OLEDs, or e-ink panels) provide immediate, line-of-sight cues to the operator. These may signal states such as “too high,” “sweep too fast,” or “insufficient overlap.” The indicator intensity or color transitions proportionally to the magnitude of deviation. These fixtures are ruggedized for field use and visible under bright sunlight or night-vision conditions.

In some implementations, vibrotactile motors embedded in the detector handle, shaft, or head generate graded vibration patterns proportional to the detected deviation magnitude (e.g., vibration intensity increases with head-height error). Distinct haptic signatures differentiate between error types, such as short pulses for angular tilt versus long pulses for sweep-speed correction, allowing operators to interpret guidance purely through touch.

In some implementations, wearable actuators integrated into belts, wristbands, forearm sleeves, shoulder straps, or training vests deliver directional or intensity-coded feedback. For example, left-side pulses may cue correction toward the right, or rhythmic pulsing may prompt cadence adjustment. These devices communicate wirelessly with trainer process 110 and synchronize timing with other feedback modalities for coherent multisensory guidance.

In some implementations, large wall-mounted or tripod-mounted displays positioned down-range or adjacent to the training lane provide simplified graphical feedback visible from a distance. The displays may present “go/no-go” color bars, sweep-progress indicators, or a god’s-eye overhead map illustrating the trainee’s coverage footprint. Both operator and instructor can reference these visuals for situational alignment without relying on wearable optics.

In some implementations, portable tablets or handheld monitors display live performance metrics, textual prompts, and scenario data streams for either the trainee or instructor. These devices may mirror headset content or show additional analytics such as sweep-rate graphs and scoring panels. The same interface allows instructors to adjust thresholds or pause/resume sessions in real time.

In some implementations, audio feedback may be provided through open-ear, earbud, or bone-conduction headsets delivering spatialized tones, speech, or cues positioned in 3D space relative to the operator. For example, audio panning can indicate under-scanned regions, metronomic tones can regulate sweep rhythm, and verbal prompts can confirm correct coverage or angle. Spatialized cues maintain awareness of the surrounding environment and are compatible with hearing-protection gear.

In some implementations, low-power laser or projection modules attached to the detector or mounted externally cast lines, grids, or arrows onto the ground to represent optimal sweep lanes, overlap boundaries, or permissible head-height corridors. The trainee keeps the detector head within the projected “rail” for visual reinforcement of consistency. Infrared or night-vision-compatible variants enable use in low-light or covert training environments.

In some implementations, optional low-profile boundary markers or wireless beacons positioned along the lane edges provide positional reference without requiring mats or rigid flooring. These markers can emit faint light, RF signals, or coded vibrations that synchronize with AR overlays, anchoring spatial cues to the real environment while maintaining full mobility.

In some implementations, a compact, detector-mounted micro-display angled toward the operator provides essential information, such as deviation arrows, numeric height readouts, or sweep-speed gauges, without the need for a head-worn device. The micro-display is sunlight-readable, low-power, and directly linked to trainer process 110 through the detector’s onboard controller.

In some implementations, dedicated instructor feedback interfaces, including tablets, dashboard displays, or mirrored headsets, provide a comprehensive view of all active trainees. These interfaces visualize detector telemetry, performance parameters, and real-time feedback cues in synchronized overlays, enabling remote coaching and after-action review. The OFS supports accessibility and mission-specific variants (e.g., color-safe palettes, NVG-compatible visuals, or low-audio modes). During interrogation or localization modes, the instructor interface may display ground-locked reticles, centroid markers, or 3D footprint outlines, while directional haptics or spatial audio guide the operator toward unscanned regions.

In some implementations, collectively, these feedback modalities allow trainer process 110 to select, blend, or transition between feedback interfaces dynamically based on environment, user preference, or operational phase. During training, trainer process 110 may prioritize high-density visual feedback, whereas in live operations, minimal haptic or audio cues preserve discretion. This unified feedback framework ensures the detector sweep trainer provides both immersive skill development and real-time operational support, enhancing efficiency, safety, and confidence across all phases of detector use.

In some implementations, presenting the feedback outputs to the user may include transitioning 316 between a scanning state and an interrogation state, wherein the feedback outputs presented to the user include state-specific cues for at least one of centroid refinement, depth estimation, footprint estimation, standardized mark workflows and standardized report workflows. For instance, trainer process 110 not only supports the scanning phase, where operators conduct wide-area sweeps to locate potential targets, but also transitions seamlessly into an interrogation state, where operators perform localized analysis of a detected anomaly. During this transition, trainer process 110 modifies both its tracking logic and its feedback presentation modes to provide interrogation-specific visual, haptic, and auditory cues as discussed above. The purpose is to guide the operator through a standardized process of refining the target centroid, estimating its footprint and depth, marking its position, and recording the result according to mission-specific protocols. This interrogation-aware workflow extends beyond the basic “alert only” feedback. It introduces an interactive, procedural layer in which the trainee (or live operator) receives dynamically tailored cues, such as ground-locked AR reticles, projected guides, or haptic steering impulses, that improve localization accuracy and promote adherence to established safety and reporting standards.

For instance, in some implementations, trainer process 110 executes a state-machine controller that governs the transition between scanning and interrogation modes. When a signal threshold, detection event, or simulated alert is triggered, trainer process 110 automatically shifts to the interrogation state. In this mode, motion-analysis filters are re-weighted to prioritize fine-scale movements, and the visual feedback layer replaces wide-area sweep overlays with localized guidance aids. Trainer process 110 may also pause or slow scoring timers, switch audio cues from rhythmic cadence to spatial localization tones, and enable additional fine-motion data sampling from the detector’s IMU and position sensors.

In some implementations, once interrogation mode is active, trainer process 110 analyzes multiple successive passes over the detected region to refine the target centroid and estimate its depth. The feedback interface may display a ground-locked reticle indicating the estimated centroid, which dynamically repositions as the operator completes cross-sweeps. Depth estimation may be computed by correlating detector signal amplitude, phase response, and sweep geometry. HMD 502 or micro-display may show a numeric or color-coded depth gauge, while haptic actuators emit intensity-modulated pulses corresponding to proximity or confidence level. This iterative loop continues until positional variance falls below a predefined threshold, confirming accurate localization.

In some implementations, trainer process 110 renders a footprint outline representing the probable spatial extent of the detected object. This outline may appear as a projected or AR overlay on the ground plane, showing confidence boundaries derived from positional dispersion data. Directional haptic or spatialized audio cues may steer the operator toward unsampled regions of the footprint, ensuring complete coverage. If the operator drifts beyond the perimeter or fails to achieve uniform sweep overlap, trainer process 110 issues corrective cues to re-center the pattern.

In some implementations, trainer process 110 supports standardized mark-and-report workflows to ensure consistent documentation of detection events. Once centroid and footprint confidence exceed predefined thresholds, the trainee is prompted, via visual or voice instruction, to perform a virtual or physical mark. Trainer process 110 may project or AR-render a virtual flag, or instruct the operator to deploy an actual field marker. Immediately afterward, the interface transitions to a reporting overlay that captures required metadata such as location coordinates, target ID, confidence score, depth estimate, and environmental conditions. LMS 504 and LRS 506 for archival and later after-action review.

In some implementations, instructor or supervisory interfaces mirror the operator’s interrogation state in real time, allowing instructors to monitor progress and intervene when safety or procedural anomalies are detected. For example, the instructor console may display both the live AR visualization and a 3D top-down model of the interrogation area. If the operator bypasses a required checklist step, such as confirming isolation distance or second-sweep verification, trainer process 110 issues an alert or locks progression until compliance is achieved. This ensures trainees internalize standardized workflows for safe and repeatable target interrogation consistent with field doctrine.

Together, these implementations enable the trainer process 110 to guide operators not just through detection, but through the complete interrogation and documentation lifecycle. By providing state-specific feedback for centroid refinement, depth and footprint estimation, and reporting, trainer process 110 establishes a closed-loop methodology that mirrors real operational procedures, ensuring that trainees emerge with both technical proficiency and procedural discipline applicable to real-world detection missions.

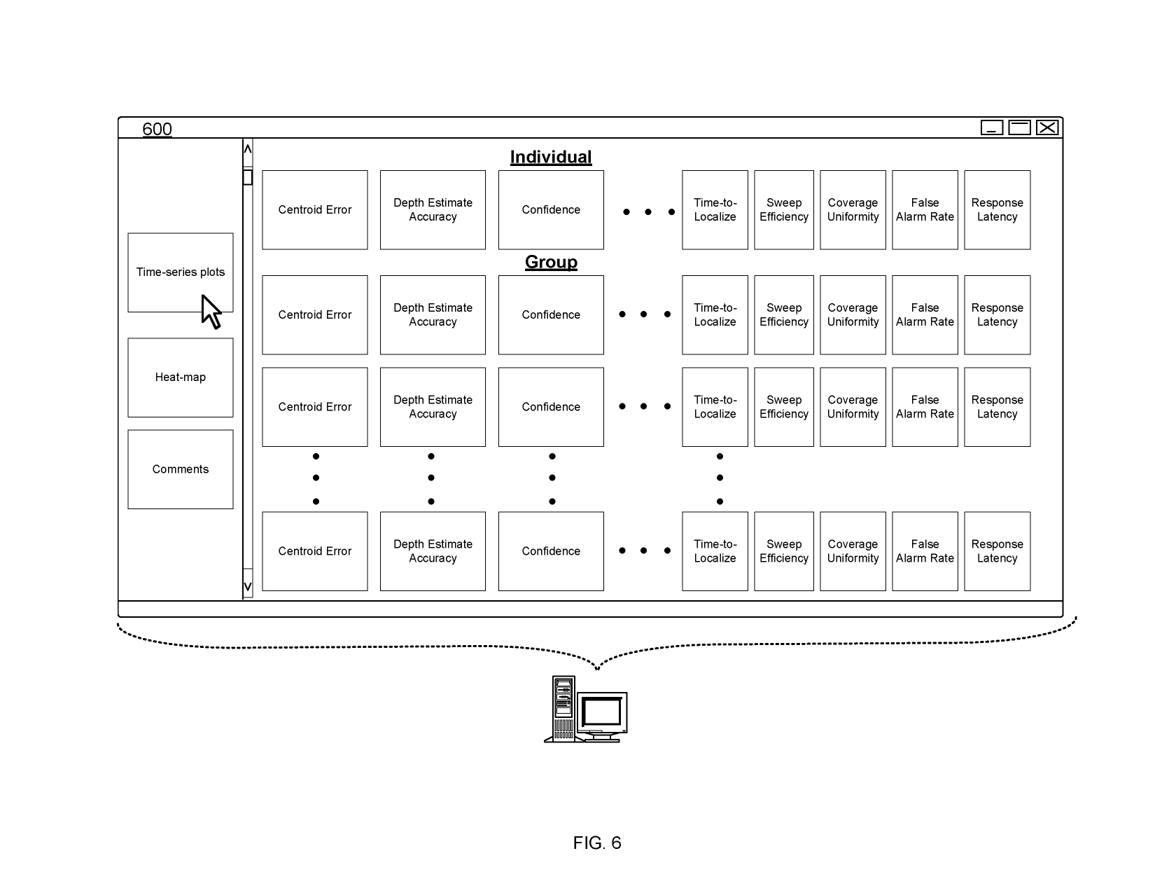

In some implementations, trainer process 110 may track 318 individual performance of the user, track 320 group performance from a plurality of users, store 322 training data, and generate 324 performance reports for the user and the plurality of users. For instance, trainer process 110 includes performance-tracking and data-management capabilities that capture, analyze, and report both individual and group training outcomes. During each session, telemetry and usage data from one or more handheld detectors are continuously recorded, correlated with scenario parameters, and stored as structured training datasets. These datasets form the basis for real-time feedback, post-session analytics, and long-term performance trend analysis. Trainer process 110 may automatically generate reports (e.g., report 600 in the example implementation of FIG. 6) summarizing quantitative metrics, such as sweep efficiency, coverage uniformity, false-alarm rate, response latency, centroid error, depth estimate accuracy, and confidence, for both individual operators and teams. When deployed across an enterprise network, these reports may be aggregated to assess organizational readiness, training throughput, and comparative performance across sites.

In some implementations, trainer process 110 computes individualized metrics derived from detector telemetry, headset orientation, and OFS feedback events. Parameters such as head-height stability, sweep cadence consistency, lateral coverage efficiency, and angular precision are aggregated into a Performance Quality Index (PQI) for each trainee. The PQI is time-stamped, scenario-tagged, and stored in the LMS 504 and LRS 506. Individual reports may include time-series plots, heat-map visualizations of sweep paths, and auto-generated comments highlighting strengths and areas for improvement. These data allow instructors to monitor progression, customize difficulty levels, and provide targeted coaching based on empirical evidence rather than subjective observation.

In some implementations, when multiple trainees operate simultaneously, trainer process 110 aggregates telemetry from all active detector devices within the shared tracking environment. Trainer process 110 computes group-level metrics such as collective coverage percentage, average inter-operator spacing, overlap ratio, and temporal coordination efficiency. Real-time visualization overlays may show each team member’s sweep path in color-coded traces projected on the instructor’s display or rendered as a composite “coverage map” visible to the group in augmented reality. An analytics engine of trainer process 110 identifies under-scanned regions or redundant overlaps, prompting adaptive cues that enhance teamwork and formation discipline. This cooperative tracking mode mirrors real-world clearance missions where synchronized team behavior is essential for safety and efficiency.

In some implementations, trainer process 110 supports competitive training modes in which multiple operators engage simultaneously under timed or scored conditions. The gamification engine assigns scores based on accuracy, speed, and efficiency metrics, normalizing results across identical scenarios. Leaderboards, ranking tiers, and achievement badges are updated in real time and displayed via HMD 502, mobile tablet, or external monitor. Competitive modules may also include “challenge drills,” where trainees attempt to outperform AI-generated baselines or peer averages. This gamified structure enhances motivation and promotes repeated practice while reinforcing proper technique through quantified self-comparison.

In some implementations, the trainer’s modular and network-centric design allows multiple geographically separated training facilities to participate in synchronized sessions. Each site operates as a node connected through the enterprise network 112, sharing scenario definitions, performance data, and AI-generated analytics. Cross-site synchronization is achieved using standardized data protocols (e.g., xAPI, MQTT, or secure REST endpoints) managed by the LMS 504 and LRS 506. Instructors from different locations can co-develop scenarios, monitor concurrent sessions, or exchange performance summaries through a unified dashboard. Trainees can compare their results with peers enterprise-wide, fostering collaboration and consistency in training standards.

In some implementations, trainer process 110 automatically compiles session data into performance reports that include numerical scores, qualitative summaries, and visual overlays of detector paths and feedback events. The report-generation engine applies predictive analytics to detect trends such as plateaued improvement or recurrent procedural errors. These insights enable instructors to adapt curriculum pacing or assign remedial modules. At the enterprise level, aggregated analytics reveal systemic patterns, such as equipment bias, scenario imbalance, or training bottlenecks, informing strategic decisions about resource allocation and detector-technology updates.

By combining individual tracking, group coordination analytics, competitive scoring, and enterprise-scale synchronization, trainer process 110 provides a comprehensive, data-driven ecosystem for detector training and operational assessment. Unlike prior solutions limited to single-user, local-only evaluations, this architecture enables scalable, networked, and continuously improving performance management across both training and live operational domains.

### Example Use Case: Military Training Scenario for Explosive Device Detection

Sergeant Smith, a recently assigned Explosive Ordnance Disposal (EOD) specialist, has been tasked with completing advanced training to improve his proficiency in detecting and neutralizing buried explosive devices. This training is critical, as the region he is deploying to has a high incidence of improvised explosive devices (IEDs) and legacy landmines. Traditionally, EOD personnel train in designated practice fields using physical detectors under the supervision of experienced instructors. However, with limited training resources and the high cost of physical training areas, the command decides to leverage the interactive extended reality detector sweep trainer to enhance training effectiveness and reduce logistical challenges.

Sergeant Smith arrives at the training facility where the interactive detector sweep trainer has been set up in a simulated outdoor environment. He is issued his standard-issue detector device (and/or any type of suit or gloves with sensors that would enhance the movement tracking), which has been equipped with a detector-mounted sensor module that enables precise tracking of his movements. After donning a hands-free extended reality headset, he enters the defined training area where external tracking sensors are positioned to create a detailed tracking zone.

The training supervisor initiates trainer process 110, and Sergeant Smith performs a brief calibration process. He moves the detector through a series of predefined motions while the system captures his position and the detector’s orientation. The central processing unit analyzes the calibration data to establish the coordinate system for the training area, ensuring accurate tracking during the session. The instructor selects a beginner-level training scenario designed to replicate a low-threat environment with minimal background interference that might otherwise distort sensor indications and complicate training. As Sergeant Smith begins scanning the simulated training lane, trainer process 110 provides real-time feedback through the headset’s heads-up display (HUD). Indicators show the exact height of the detector head relative to the ground, along with the sweep speed and lateral coverage. When the detector deviates from the optimal height range, the HUD displays a yellow warning bar, prompting Sergeant Rodriguez to adjust his stance.

As Sergeant Smith moves through the training area, trainer process 110 introduces simulated subsurface threat objects (e.g., small metal fragments, inert IED components) that are digitally rendered but not visible to the naked eye. When the detector produces an initial indication, trainer process 110 evaluates sweep stability and coverage. If sweep speed, head height, or detector angle diverge from prescribed parameters, the Operator Feedback Subsystem (e.g., HUD, external display, audio, or haptics) issues targeted cues to correct technique and stabilize the signal. In some instances, the scenario continues into interrogation and localization: trainer process 110 coaches orthogonal cross-sweeps to refine the centroid, reinforces height/cadence for localization, may prompt a simulated or real secondary pass (e.g., pinpointer mode), guides a depth/footprint estimate, and supports virtual/physical marking. Localization outputs (e.g., centroid, depth estimate, confidence, time-to-localize) are logged for debrief and adaptive progression.

After successfully completing the initial scenario, the instructor escalates the training by introducing a more complex environment. The new scenario simulates an area with varying terrain elevations and metallic debris, requiring Sergeant Smith to modify his scanning technique. Trainer process 110 dynamically adapts to his performance, using an internal scoring algorithm to evaluate his ability to maintain detector height and sweep speed consistency in the more challenging environment. The scoring algorithm is a function of key performance indicators based on detector position, device handling, and other relevant human performance biometrics feedback. Trainer process 110’s LMS records his performance data and adjusts the difficulty level based on real-time analytics, pushing him to develop advanced skills. That is, adaptive learning may modify the scenario to be easier or more difficult depending on what is needed to optimize learning. If the Sergeant is lagging in skills development in a specific area of task performance, trainer process 110 may modify the scenario to focus on this area but if the Sergeant is demonstrating high proficiency trainer process 110 will present new challenges to accelerate his learning and progress towards qualifications. Trainer process 110 optimizes learning by adapting the scenario to the players performance in real-time.

At the end of the session, Sergeant Smith receives a detailed debrief report generated by the LMS of trainer process 110. The debrief also includes interrogation/localization metrics (centroid error, depth estimate accuracy, confidence, and time-to-localize) with overlays of cross-sweep paths and coverage heatmaps. The report includes metrics on his overall detection accuracy, adherence to optimal parameters, and areas for improvement. A visual playback of the session is available, allowing Sergeant Smith to view his movement patterns and compare them to the ideal scanning techniques demonstrated in the HUD. Trainer process 110 also suggests targeted practice sessions based on his performance, highlighting specific scenarios where he struggled (e.g., maintaining detector height over sloped terrain).

As a result of the training, Sergeant Smith demonstrates significant improvement in his detector handling skills over the course of several training sessions. He reports higher confidence in his ability to detect hidden threats and expresses satisfaction with the immediate feedback and adaptive learning features. The command notes a reduction in training time and a marked increase in overall proficiency scores compared to previous training cycles conducted solely with physical detectors and live instructors. Operators also show improved localization accuracy (reduced centroid error and faster confirmation time) and more consistent marking/report procedures.

### Example Use Case: Commercial Utility Detection Training Scenario

Laura is a newly hired field technician at a utility company, tasked with conducting surveys and locating underground power lines, telecommunications cables, and water pipelines. The company’s goal is to reduce the number of false positives and eliminate the risk of accidental utility damage during excavation and maintenance projects. In traditional training environments, Laura would learn through hands-on use of physical detectors in a controlled space, guided by an experienced supervisor. However, with increasing workloads and limited training resources, the company has adopted the interactive extended reality detector sweep trainer to streamline the training process, provide consistent performance feedback, and reduce the dependency on senior field staff.

Laura arrives at the company’s training facility, where the interactive detector sweep trainer has been configured to simulate various underground utility layouts. She is provided with a standard field detector equipped with a sensor module that captures real-time tracking data on her movements and device positioning. After calibrating the detector and donning a mixed reality headset, Laura steps into a simulated training lane designed to replicate the conditions of a complex urban environment, including the presence of buried utility lines and common sources of interference.

Trainer process 110 initiates the training software and guides Laura through a calibration process to establish the correct alignment of the detector’s tracking data with the training environment. She moves the detector through predefined positions and motions while the system captures her movements and calibrates its internal coordinate system. The instructor selects a beginner-level scenario that simulates a typical suburban environment with minimal interference. As Laura begins scanning the training lane, trainer process 110 provides real-time feedback through her headset’s heads-up display (HUD or HMD 502). Visual indicators show the height of the detector head relative to the ground, along with sweep speed and coverage area. When she moves too quickly or lifts the detector too high, a warning prompt appears, advising her to slow down or lower the device.

After the initial scenario, the instructor introduces a denser urban environment with overlapping utilities and common interference sources. When Laura receives an initial indication, trainer process 110 assesses sweep stability and coverage; if speed, height, or coil angle drift, the Operator Feedback Subsystem (e.g., HUD, external display, audio, or haptics) provides immediate cues to restore proper technique. Trainer process 110 can flag likely interference patterns (e.g., adjacent line coupling) and prompt confirming passes to reduce false positives.

In some instances, the scenario continues into interrogation and localization: trainer process 110 guides orthogonal cross-sweeps to refine the centroid, enforces height/cadence tolerances for localization, may prompt a simulated or real secondary pass (e.g., pinpointer/GPR mode), supports depth and lateral footprint estimation, and enables virtual/physical marking for mapping. Localization results (centroid, depth estimate, confidence, time-to-localize) are stored for debrief and adaptive sequencing.

Trainer process 110 dynamically adapts to Laura’s performance by increasing the complexity of the signals detected and simulating false positives that require careful differentiation. As she progresses through the scenario, trainer process 110 evaluates her response time and decision-making skills, providing her with targeted feedback on how to distinguish between closely spaced utilities or identify artifacts caused by signal overlap.

At the end of the session, Laura receives a detailed performance report generated by trainer process 110’s LMS. The report includes interrogation/localization metrics (centroid error, depth estimate accuracy, confidence, and time-to-localize) with visual overlays of cross-sweeps and coverage heatmaps. The report includes metrics on her detection accuracy, adherence to optimal parameters, and areas for improvement, and trainer process 110 suggests targeted training sessions to improve specific skills, such as signal differentiation or maintaining consistent coverage in high-interference areas.

Over several training sessions, Laura shows marked improvement in her ability to accurately identify and map underground utilities. Her supervisor notes a decrease in the time required to conduct field surveys and an increase in overall detection accuracy. Laura expresses satisfaction with the real-time feedback and adaptive learning features, which have helped her build confidence and proficiency without the need for extensive hands-on oversight. Operators also show improved localization accuracy (reduced centroid error and faster confirmation time) and more consistent marking/report procedures.

The terminology used herein is for the purpose of describing particular implementations only and is not intended to be limiting of the disclosure. As used herein, the singular forms "a", "an" and "the" are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms "comprises" and/or "comprising," when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set — in other words, in some circumstances a “set” may have zero elements. The term “non-empty set” may be used to indicate exclusion of the empty set — that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set — in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

The implementations disclosed herein are only examples, and the scope of this disclosure is not limited to them. Implementations may include all, some, or none of the components, elements, features, functions, operations, or steps of the embodiments disclosed herein. The dependencies or references back in the attached claims are chosen for formal reasons only; however, any subject matter resulting from a deliberate reference back to any previous claims can be claimed as well, so that any combination of claims and the features thereof are disclosed and can be claimed regardless of the dependencies chosen in the attached claims. The subject-matter that can be claimed comprises not only the combinations of features as set out in the attached claims, but also any other combination of features in the claims, where each feature mentioned in the claims can be combined with any other feature or combination of other features in the claims. Furthermore, any of the implementations and features described or depicted herein can be claimed in a separate claim and/or in any combination with any implementation or feature described or depicted herein or with any of the features of the attached claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, by a computing device of a handheld detector, usage data of the handheld detector operated by a user;
determining, based on the usage data received from the handheld detector, performance parameters for how the user is operating the handheld detector;
generating, based on the performance parameters, feedback outputs for how the user is operating the handheld detector; and
presenting the feedback outputs to the user.

2. The computer-implemented method of claim 1, wherein presenting the feedback outputs to the user includes presenting the feedback outputs through at least one of a head-mounted display, an external display, an on-detector visual indicator, an on-detector haptic actuator, a wearable haptic device, a spatialized audio device, a projection guidance, a laser guidance, and a mobile display.

3. The computer-implemented method of claim 1, wherein presenting the feedback outputs to the user includes transitioning between a scanning state and an interrogation state, wherein the feedback outputs presented to the user include state-specific cues for at least one of centroid refinement, depth estimation, footprint estimation, standardized mark workflows and standardized report workflows.

4. The computer-implemented method of claim 1, wherein receiving the usage data of the handheld detector includes receiving at least one of head height of the handheld detector, sweep cadence of the handheld detector, lateral coverage of the handheld detector, and angle of the handheld detector.

5. The computer-implemented method of claim 1, wherein receiving the usage data of the handheld detector includes receiving the usage data from external tracking sensors and internal motion tracking sensors of the handheld detector.

6. The computer-implemented method of claim 1, wherein receiving the usage data of the handheld detector includes receiving the usage data of the handheld detector through a simulation of operational conditions.

7. The computer-implemented method of claim 1 further comprising:
tracking individual performance of the user;
tracking group performance from a plurality of users;
storing training data; and
generating performance reports for the user and the plurality of users.

8. A computing system including one or more processors and one or more memories configured to perform operations comprising:
receiving, by a computing device of a handheld detector, usage data of the handheld detector operated by a user;
determining, based on the usage data received from the handheld detector, performance parameters for how the user is operating the handheld detector;
generating, based on the performance parameters, feedback outputs for how the user is operating the handheld detector; and
presenting the feedback outputs to the user.

9. The computing system of claim 8, wherein presenting the feedback outputs to the user includes presenting the feedback outputs through at least one of a head-mounted display, an external display, an on-detector visual indicator, an on-detector haptic actuator, a wearable haptic device, a spatialized audio device, a projection guidance, a laser guidance, and a mobile display.

10. The computing system of claim 8, wherein presenting the feedback outputs to the user includes transitioning between a scanning state and an interrogation state, wherein the feedback outputs presented to the user include state-specific cues for at least one of centroid refinement, depth estimation, footprint estimation, standardized mark workflows and standardized report workflows.

11. The computing system of claim 8, wherein receiving the usage data of the handheld detector includes receiving at least one of head height of the handheld detector, sweep cadence of the handheld detector, lateral coverage of the handheld detector, and angle of the handheld detector.

12. The computing system of claim 8, wherein receiving the usage data of the handheld detector includes receiving the usage data from external tracking sensors and internal motion tracking sensors of the handheld detector.

13. The computing system of claim 8, wherein receiving the usage data of the handheld detector includes receiving the usage data of the handheld detector through a simulation of operational conditions.

14. The computing system of claim 8, wherein the operations further comprise:
tracking individual performance of the user;
tracking group performance from a plurality of users;
storing training data; and
generating performance reports for the user and the plurality of users.

15. A computer program product residing on a computer readable storage medium having a plurality of instructions stored thereon which, when executed across one or more processors, causes at least a portion of the one or more processors to perform operations comprising:
receiving, by a computing device of a handheld detector, usage data of the handheld detector operated by a user;
determining, based on the usage data received from the handheld detector, performance parameters for how the user is operating the handheld detector;
generating, based on the performance parameters, feedback outputs for how the user is operating the handheld detector; and
presenting the feedback outputs to the user.

16. The computer program product of claim 15, wherein presenting the feedback outputs to the user includes presenting the feedback outputs through at least one of a head-mounted display, an external display, an on-detector visual indicator, an on-detector haptic actuator, a wearable haptic device, a spatialized audio device, a projection guidance, a laser guidance, and a mobile display.

17. The computer program product of claim 15, wherein presenting the feedback outputs to the user includes transitioning between a scanning state and an interrogation state, wherein the feedback outputs presented to the user include state-specific cues for at least one of centroid refinement, depth estimation, footprint estimation, standardized mark workflows and standardized report workflows.

18. The computer program product of claim 15, wherein receiving the usage data of the handheld detector includes at least one of:
receiving at least one of head height of the handheld detector, sweep cadence of the handheld detector, lateral coverage of the handheld detector, and angle of the handheld detector; and
receiving the usage data from external tracking sensors and internal motion tracking sensors of the handheld detector.

19. The computer program product of claim 15, wherein receiving the usage data of the handheld detector includes receiving the usage data of the handheld detector through a simulation of operational conditions.

20. The computer program product of claim 15, wherein the operations further comprise:
tracking individual performance of the user;
tracking group performance from a plurality of users;
storing training data; and
generating performance reports for the user and the plurality of users.
